(19) United States
(12) Patent Application Publication
(10) Pub. No.: US 2018/0279563 A1
(43) Pub. Date: Oct. 4, 2018

(54) System and Methods for Mimicking the Environmental Conditions of a Habitat

(71) Applicants: Jared Wolfe, Calgary (CA); Tom Lam, Calgary (CA); Apple Mahmud, Calgary (CA); Shargeel Hayat, Calgary (CA); Lucas Gozalvez, Seville (ES); Jonathan Caceres, Seville (ES); Ruben Jimenez, Seville (ES)

(72) Inventors: Jared Wolfe, Calgary (CA); Tom Lam, Calgary (CA); Apple Mahmud, Calgary (CA); Shargeel Hayat, Calgary (CA); Lucas Gozalvez, Seville (ES); Jonathan Caceres, Seville (ES); Ruben Jimenez, Seville (ES)

(73) Assignee: Biopod Systems Inc., Calgary (CA)

(21) Appl. No.: 15/471,572

(22) Filed: Mar. 28, 2017

(51) Int. Cl. A01G 9/24; A01K 1/00; A01G 9/02; A01G 25/02; G06N 3/08

(52) U.S. Cl. CPC A01G 9/246; A01K 1/0064; A01K 1/0052; A01K 1/0076; G06N 3/08; A01G 9/025; A01G 9/247; A01G 25/02; A01K 1/0082

(57) ABSTRACT

A system for mimicking the environmental conditions of a habitat includes an enclosure and a ventilation assembly. A ventilation strip extends horizontally through a sidewall of the enclosure. The ventilation strip includes first and second inner channels separated by an inner fin. A ventilation opening(s) allows communication between the interior of the enclosure and the inner channels. An air fan in fluid communication with the first inner channel provides airflow into the first inner channel to create a low-pressure zone over the ventilation opening, thereby drawing air through the ventilation opening and into the enclosure from the exterior of the enclosure through the second inner channel. In some embodiments, a vertical growing assembly having a mounting panel and a plurality of cells is provided. Each cell is adapted for receiving substrate for growing an organism. A method for training an artificial neural network to control said system is also provided.

### TECHNICAL FIELD

The invention relates to a system and methods for mimicking the environmental conditions of a habitat.

### BACKGROUND

Systems such as vivariums, terrariums, aquariums or greenhouse systems are used to recreate the conditions corresponding to certain habitats. These systems typically include an enclosure which accommodates corresponding actuators and devices to create certain physical conditions inside the enclosure.

A drawback associated with some of these systems is that they are unable to precisely replicate the subtle daily and annual fluctuations of UV, visible and infrared light saturation, humidity, temperature, oxygen saturation, and airflow found in natural habitats. Furthermore, the ability of a single system to adapt to replicate a wide range of different habitats (desert, temperate forest, tropical rainforest, cloud forest, etc) tends to be limited. For example, terrariums often have difficulty introducing and controlling humidity independently of misting, and can have difficulty providing stable heat from both substrate and air sources that are independently controlled. Electromagnetic radiation in terrariums is often not controlled and can expose the terrarium inhabitants to unnatural levels of radiation.

Additionally, prior art systems tend to have limited capability to expand or scale the system to fit a wide range of different sized environments.

There is therefore a need for a system and for a method for mimicking the environmental physical conditions of a habitat which will overcome at least one of the above-identified drawbacks.

### BRIEF SUMMARY

According to one aspect, there is provided a system for mimicking the environmental conditions of a habitat, the system comprising: an enclosure for housing at least one organism, the enclosure including a roof, a floor and a plurality of sidewalls extending vertically between the roof and the floor; a ventilation assembly for providing air from outside the enclosure into the enclosure, the ventilation assembly comprising: a ventilation strip extending horizontally through one of the sidewalls, the ventilation strip having a first strip end and a second strip end, the ventilation strip including: a first inner channel extending longitudinally between the left and right strip ends; a second inner channel extending longitudinally between the left and right strip ends adjacent the first inner channel, the second inner channel being in communication with an exterior of the enclosure; an inner fin extending between the first inner channel and the second inner channel for separating the first inner channel from the second inner channel; at least one ventilation opening defined in the ventilation strip for allowing communication between the first inner channel and an interior of the enclosure and between the second inner channel and the interior of the enclosure; and an air fan in fluid communication with the first inner channel, the air fan being adapted for providing a flow of air into the first inner channel when operated, said flow of air creating a low-pressure zone over the at least one ventilation opening when entering the enclosure through the ventilation opening, thereby drawing air through the ventilation opening and into the enclosure from the exterior of the enclosure through the second inner channel.

In one embodiment, the system further comprises at least one sensor disposed inside the enclosure, each one of the at least one sensor being configured to measure at least one environmental parameter value within the enclosure; at least one actuator disposed inside the enclosure, each one of the at least one actuator being configured to adjust the at least one environmental parameter; a controller operatively connected to the at least one sensor and to the at least one actuator for controlling the at least one environmental parameter according to the measured environmental parameter value.

In one embodiment, the plurality of sidewalls include a rear wall, a front wall disposed opposite the rear wall and left and right opposite lateral walls extending between the rear and front walls.

In one embodiment, the front wall includes an upper front wall panel adjacent the roof and a lower front wall panel adjacent the floor, the ventilation strip extending horizontally between the upper and lower front wall panels.

In one embodiment, the left strip end located adjacent the left lateral wall and the right strip end is located adjacent the right lateral wall.

In one embodiment, the inner fin is curved.

In one embodiment, the inner fin is convex towards the first inner channel.

In one embodiment, the ventilation strip includes a top face contacting the upper front wall panel and a bottom face contacting the lower front wall panel.

In one embodiment, the top face is planar.

In one embodiment, the ventilation opening is defined in the top face.

In one embodiment, each ventilation opening is elongated and extends transversely to the ventilation strip.

In one embodiment, each ventilation opening includes a first end located towards the first inner channel and a second end located towards the second inner channel.

In one embodiment, the at least one ventilation opening includes a plurality of spaced-apart ventilations openings.

In one embodiment, the inner fin member includes a base end secured to the bottom face of the ventilation strip and a free end opposite the base end.

In one embodiment, the free end of the inner fin abuts the top face below the ventilation opening to divide the ventilation opening into a first opening portion allowing communication between the first inner channel and the interior of the enclosure and a second opening portion allowing communication between the second inner channel and the interior of the enclosure.

In one embodiment, the second opening portion is larger than the first opening portion.

In one embodiment, the ventilation opening includes a pair of parallel straight side edges and first and second semicircular end edges extending between the side edges, the first semicircular end edge being disposed towards the interior of the enclosure and the second semicircular end edge being disposed towards the exterior of the enclosure.

In one embodiment, the free end of the inner fin is disposed between the straight side edges and the first semicircular end edge such that the first opening portion is defined between the free end of the inner fin and the first semicircular end edge.

In one embodiment, the inner fin tapers from the base end to the free end.

In one embodiment, the bottom face includes at least one inlet opening allowing communication between the second inner channel and the exterior of the enclosure.

In one embodiment, at least one inlet opening includes a plurality of spaced-apart inlet openings.

In one embodiment, the bottom face includes a panel receiving recess extending longitudinally between the left and right strip ends, the panel receiving recess being sized and shaped to receive a top edge of the lower front wall panel.

In one embodiment, the ventilation strip further includes a heating element extending longitudinally between the left and right strip ends, the heating element being disposed adjacent the first inner channel to provide heat to air within the first inner channel.

In one embodiment, the heating element has a cylindrical cross-section and the bottom face of the ventilation strip includes a heating element recess having a corresponding cylindrical cross-section for receiving the heating element.

In one embodiment, the heating element includes a heating cable.

According to another aspect, there is provided a system for mimicking the environmental conditions of a habitat, the system comprising: an enclosure for housing at least one organism, the enclosure including a roof, a floor and a plurality of sidewalls extending vertically between the roof and the floor; a vertical growing assembly located inside the enclosure for allowing the at least one organism to grow on one of the sidewalls, the vertical growing assembly including: a mounting panel disposed vertically against the one of the sidewalls; and a plurality of cells extending from the mounting panel into the enclosure, each cell being adapted for receiving substrate for growing the at least one organism.

In one embodiment, the plurality of cells comprise: a plurality of spaced-apart vertical bar members extending from the mounting panel into the enclosure; and a plurality of diagonal slats angled upwardly relative to the mounting panel and extending between the vertical bar members.

In one embodiment, the vertical growing assembly further includes: a top water distribution member disposed at a top end of the mounting panel; and a vertical irrigation pipe having an upper end operatively connected to the top water distribution member and a lower end operatively connected to an irrigation pump for dispensing water from a water reservoir through the pipe and into the top water distribution member.

In one embodiment, the top water distribution member includes at least one top drip holes to allow water from the top water distribution member to flow down towards the diagonal slats.

In one embodiment, the top water distribution member includes: a bottom portion connected to the mounting panel; and a front portion angled away from the mounting panel, the front portion defining an upper horizontal edge located away from the mounting panel.

In one embodiment, each top drip holes is spaced from the bottom portion for allowing water to accumulate on the bottom portion before flowing through the top drip holes when water is provided in the top water distribution member.

In one embodiment, each top drip hole includes an indent extending in the front portion towards the bottom portion.

In one embodiment, the top water distribution member further includes at least one adjustable stopper, each one of the at least one adjustable stopper being adapted to at least partially block one of the at least one top drip holes.

In one embodiment, the vertical growing assembly further includes at least one lower water distribution member, each one of the at least one lower water distribution member extending between a corresponding row of diagonal slats and the mounting panel.

In one embodiment, the lower water distribution member includes a plurality of lower drip holes to allow water from the lower water distribution member to flow downwardly towards the floor of the enclosure.

In one embodiment, the diagonal slats are horizontally spaced away from the mounting panel to allow water dripping from the top water distribution member down through the top drip holes to drip between the diagonal slats and the mounting panel and to be received in the lower water distribution member.

According to yet another aspect, there is provided a method for training an artificial neural network to control a system for mimicking the environmental conditions of a habitat, the system including an enclosure for housing at least one organism, at least one sensor disposed inside the enclosure, each one of the at least one sensor being configured to measure at least one environmental parameter value within the enclosure, and at least one actuator disposed inside the enclosure, each one of the at least one actuator being configured to adjust the at least one environmental parameter, the method comprising: providing a first initial data subset containing a first plurality of input parameter values and corresponding output parameter values; providing a second initial data subset containing a second plurality of input parameter values and corresponding output parameter values; combining the first and second initial data subsets to form an initial data set; dividing the initial data set into a training data subset and a testing data subset; using the training data subset to train the artificial neural network; using the testing data subset to test the trained artificial neural network.

In one embodiment, providing a first initial data subset includes: randomly generating input parameter values; inputting the input parameter values into a plurality of base algorithms, each base algorithm comparing at least one of the random parameter values to a corresponding at least one target parameter value to obtain at least one actuator command for actuating the at least one actuator.

In one embodiment, the first plurality of input parameter values includes measurement values corresponding to measurements from the at least one sensor and actuator status values corresponding to statuses of the at least one actuator.

In one embodiment, each parameter value from the first data subset and the second data subset is associated with at least one identifier corresponding to an event or state related to the at least one organism inside the enclosure.

In one embodiment, the at least one identifier includes a no-event identifier corresponding to no event being detected and a plurality of event identifiers, each event identifier corresponding to a specific event.

In one embodiment, the first initial data subset only includes parameter values associated with a no-event identifier and the second initial data subset only includes parameter values associated with event identifiers.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a top front perspective view showing a system for mimicking the environmental conditions of a habitat, in accordance with one embodiment;

FIG. 2 is a bottom front perspective view of the system illustrated in FIG. 1, showing details of a control assembly disposed in a housing secured under a base of the system;

FIG. 3 is a top rear perspective view of the system illustrated in FIG. 1;

FIG. 4 is another top front perspective view of the system illustrated in FIG. 1, with the canopy and the roof of the enclosure removed to show the interior of the enclosure;

FIG. 5 is an isolated top rear perspective view of the control assembly illustrated in FIG. 2;

FIG. 6 is a top plan view of the control assembly illustrated in FIG. 5;

FIG. 7 is a bottom plan view of the control assembly illustrated in FIG. 5, with its housing removed to show the controller;

FIG. 8A is a top front perspective view of a ventilation strip for the habitat replication system illustrated in FIG. 1;

FIG. 8B is an enlarged, partial top front perspective view of the encircled portion “8B” of the ventilation strip illustrated in FIG. 8A;

FIG. 9 is an enlarged, partial top rear perspective view of the ventilation strip illustrated in FIG. 8B;

FIG. 10A is a cross-section view of the ventilation strip illustrated in FIG. 8A, taken along line X-X;

FIG. 10B is another cross-section view of the ventilation strip illustrated in FIG. 8A, taken along line X-X, with flow lines showing air flow through the ventilation strip and into the enclosure;

FIG. 11 is a top plan view of the ventilation strip illustrated in FIG. 8A;

FIG. 12 is an enlarged, partial top plan view of the encircled portion “12” of the ventilation strip illustrated in FIG. 11;

FIG. 13 is a bottom plan view of the ventilation strip illustrated in FIG. 8A;

FIG. 14 is an enlarged, partial bottom plan view of the encircled portion “14” of the ventilation strip illustrated in FIG. 13;

FIG. 15 is an isolated top front perspective view of a vertical growing assembly for the system illustrated in FIG. 1;

FIG. 16 is a bottom front perspective view of the vertical growing assembly illustrated in FIG. 15;

FIG. 17 is a front elevation view of the vertical growing assembly illustrated in FIG. 15;

FIG. 18A is a cross-section view of the vertical growing assembly illustrated in FIG. 15, taken along line XVIII-XVIII;

FIG. 18B is a top rear perspective view of the cross-section illustrated in FIG. 18.

FIG. 19 is a cross-section view of the vertical growing assembly illustrated in FIG. 15, taken along line XIX-XIX;

FIG. 20 is a top front perspective view of a system for mimicking the environmental conditions of a habitat, in accordance with another embodiment which includes an internal airflow assembly;

FIG. 21 is a top front perspective view of an internal airflow assembly for the system illustrated in FIG. 20;

FIG. 22 is a top plan view of the internal airflow assembly for the system illustrated in FIG. 20;

FIG. 23 is a front elevation view of the internal airflow assembly for the system illustrated in FIG. 20;

FIG. 24 is a diagram of a method for training a neural network for use with the system illustrated in FIG. 1;

FIG. 25 is a flowchart of the method illustrated in FIG. 24;

FIG. 26 is a diagram showing a control system for controlling the system for mimicking the environmental conditions of a habitat illustrated in FIG. 1, in accordance with one embodiment; and

FIG. 27 is a schematic representation of a command array for actuators of the system for mimicking the environmental conditions of a habitat illustrated in FIG. 1, in accordance with one embodiment.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

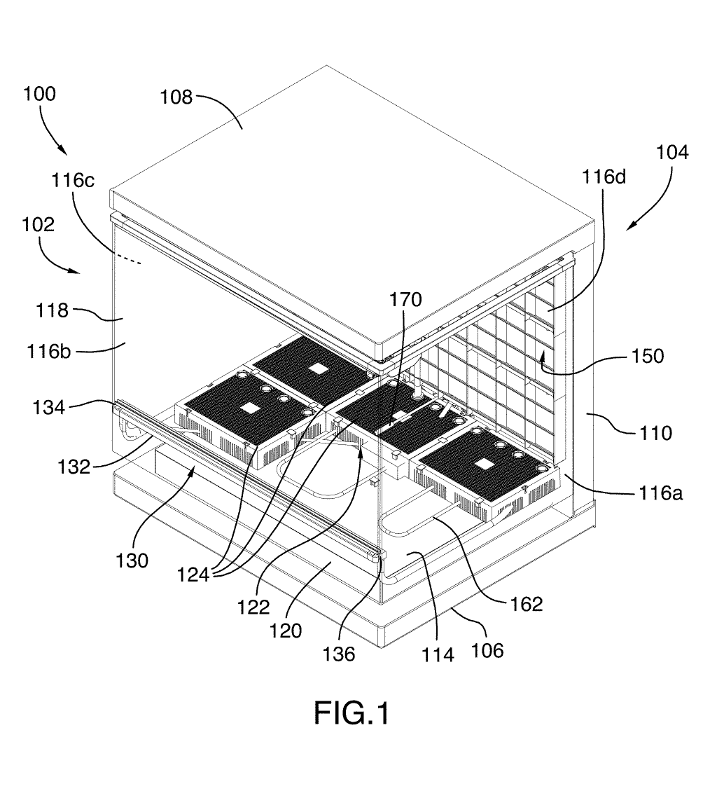

Referring first to FIGS. 1 to 4, there is provided a system 100 for mimicking the environmental conditions of a habitat, in accordance with one embodiment. The system 100 includes an enclosure 102 for housing one or more organisms (e.g. plant, fungus or animal) and a support structure 104 secured to the enclosure 102 for supporting the enclosure 102.

In the illustrated embodiment, the support structure 104 includes a generally planar base 106 adapted to be placed on a support surface, not shown, a generally planar canopy 108 disposed over the base 106 and an upright portion 110 extending generally vertically between the base 106 and the canopy 108. In this configuration, the support structure 104 is generally C-shaped and the enclosure 102 is received between the base 106, the canopy 108 and the upright portion 110.

In the illustrated embodiment, the enclosure 102 is generally rectangular and includes a roof 112, a floor 114, and a plurality of sidewalls 116 extending vertically between the roof 112 and the floor 114. Specifically, the plurality of sidewalls 116 include a rear wall 116a, a front wall 116b disposed opposite the rear wall 116a and left and right opposite lateral walls 116c, 116d extending between the rear and front walls 116a, 116b.

In one embodiment, the roof 112 and the sidewalls 116 are made of a transparent material such as glass, acrylic glass or the like to allow the inside of the enclosure 102 to be viewed from the exterior and to allow light to enter the enclosure 102 from the exterior of the enclosure 102.

In the illustrated embodiment, the front wall 116b includes an upper front wall panel 118 adjacent the roof 112 and a lower front wall panel 120 adjacent the floor 114. Specifically, the upper front wall panel 118 is hinged relative to the left lateral wall 116c and defines a door which allows access into the enclosure 102. Alternatively, the upper front wall panel 118 could instead be hinged relative to the right lateral wall 116d or the roof 112. In yet another embodiment, the door could be defined on the left lateral wall 116c, the right lateral wall 116d, the rear wall 116a or the roof 112 instead of on the front wall 116b.

In one embodiment, the system 100 could further include a door sensor located within the enclosure 102, on or near the door, to detect whether the door is opened or closed. In the illustrated embodiment, the door sensor could be secured to one of the roof 112 and the right lateral wall 116d. In an alternative embodiment in which another one of the sidewalls 116 defines the door, the door sensor could be disposed on one of the roof 112, the sidewall 116 defining the door and one of the sidewalls 116 adjacent the door. The door sensor could include a magnetic sensor, an infrared sensor or any other type of sensor which a person skilled in the art may consider to be appropriate.

In the illustrated embodiment, the system 100 further includes a spacing member 122 disposed on the floor 114 for receiving a substrate such as soil or the like and for spacing the substrate vertically above a water layer at the bottom of the enclosure 102. The floor spacer 122 is hollow and includes perforations which provide suitable aeration and/or water drainage vertically and horizontally through the floor spacer 122.

Still in the illustrated embodiment, the spacer member 122 includes a plurality of rectangular platform portions 124 which can be interconnected in a desired arrangement to create landscape effects within the enclosure 102. In one embodiment, the platform portions 124 are removable and can be entirely removed from the enclosure 102, or can be rearranged to form a different arrangement.

In the illustrated embodiment, the base 106 is hollow and is adapted to house a control assembly 126 which is operatively connected to the enclosure 102 for controlling one or more parameters associated with environmental conditions inside the enclosure 102. Specifically, the control assembly 126 includes a plurality of actuators, a plurality of conduits operatively connecting the actuators to the enclosure 102 and a housing 140 for housing the actuators and at least a portion of the conduits, as will be further explained below. It will be understood that the term “actuator” as used herein is not restricted to mechanical actuators and is also used to designate pumps, fans, heat sources, light sources and similar devices.

Still in the illustrated embodiment, the housing 140 is slidably attached to a bottom surface 142 of the base 106. Specifically, the housing 140 is configured like a drawer and can be slid out from inside the base 106 to allow the user to gain access into the housing 140. Alternatively, the housing 140 could be simply secured to the bottom surface 142 of the base 106 using fasteners such as screws, or any other appropriate fixations means.

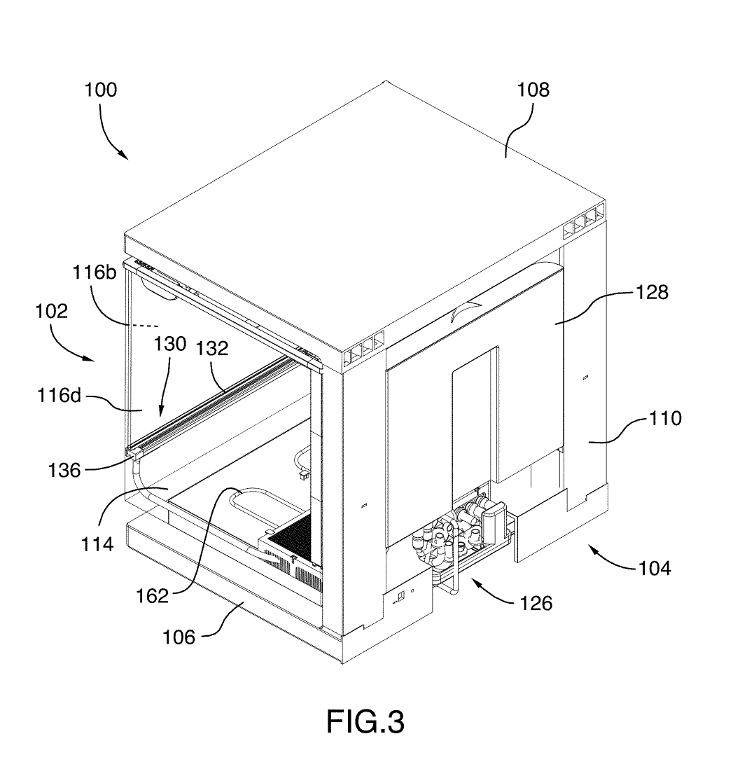

The system 100 further includes a water reservoir 128, visible in FIG. 3, which is adapted to receive water. The water reservoir 128 is operatively connected to the control assembly 126 for allowing the control assembly 126 to supply water into the enclosure 102. It will be appreciated that instead of water, the water reservoir 128 could contain nutrients, a mix of water and nutrients or any other type of substance which may need to be supplied inside the enclosure 102. In the illustrated embodiment, the water reservoir 128 is rectangular and relatively flat. Specifically, the water reservoir 128 is disposed vertically and is fastened to the upright portion 110, away from the enclosure 102. In one embodiment, the water reservoir 128 is removable to be refilled by a user when necessary. The water reservoir 128 could further be operatively coupled to a nutrient pump, not shown, and a nutrient reservoir for dispensing nutrient into the water reservoir 128 or directly in the water inside the enclosure 102.

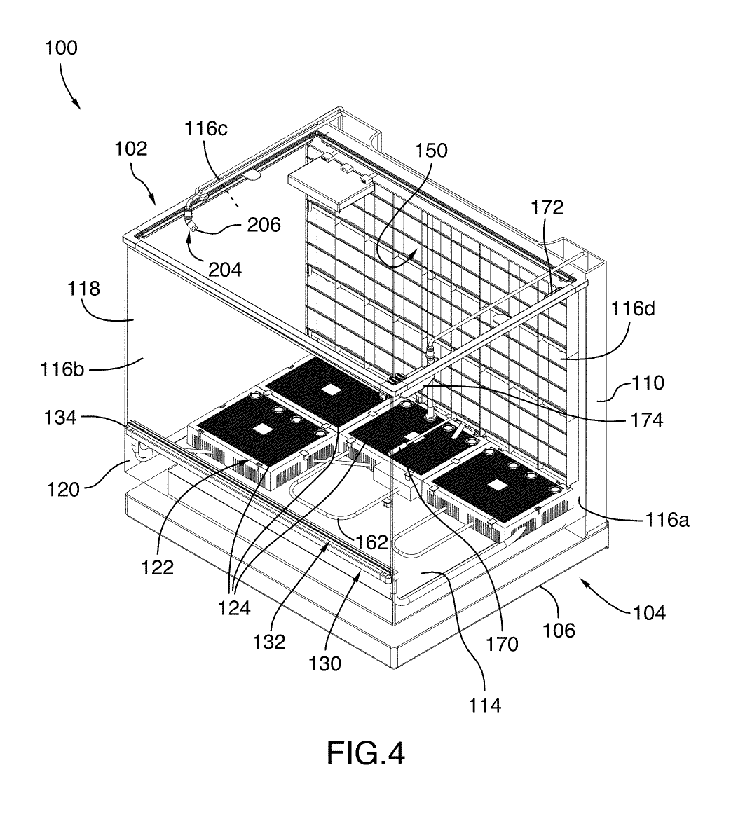

In the illustrated embodiment, the system 100 further includes a ventilation assembly 130, best shown in FIGS. 1 and 4, for providing air from the exterior of the enclosure 102 into the enclosure 102. The ventilation assembly 130 includes a ventilation strip 132 extending horizontally between the upper and lower front wall panels 118, 120. Specifically, the ventilation strip 132 has a left end 134 located adjacent the left lateral wall 116c and a right end 136 located adjacent the right lateral wall 116d. The ventilation strip 132 is operatively connected to the control assembly 126, as will be explained further below.

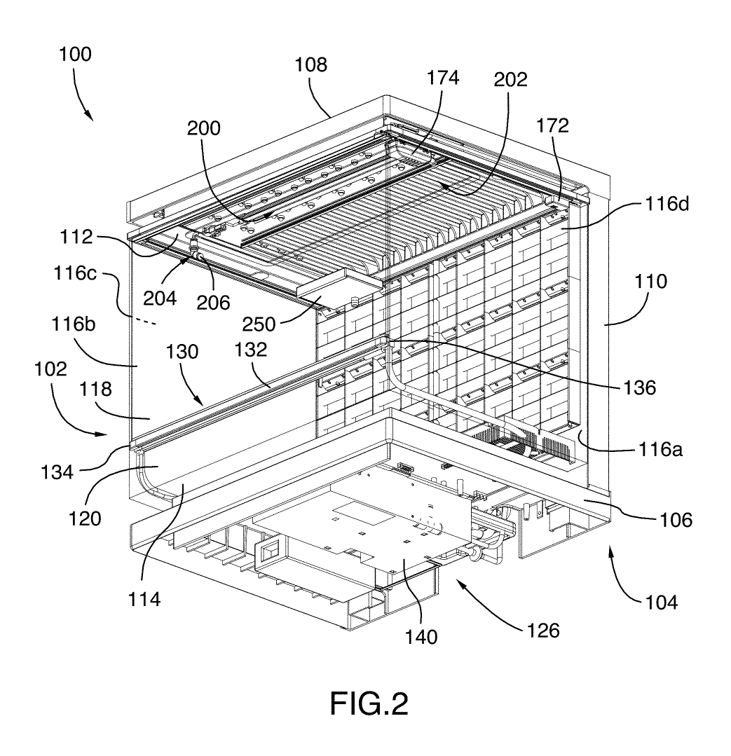

As shown in FIG. 2, the system 100 further includes a lighting assembly 200 to provide light inside the enclosure 102 through the roof 112. Specifically, the lighting assembly 200 includes a visible light source such as an array of light emitting diodes (or LEDs) configured to emit light in one or more wavelengths of the visible spectrum. The visible light source can further be dimmable for controlling an amount of visible light provided in the enclosure 102. Similarly, the lighting assembly 200 can further include an infrared light source such as an array of light emitting diodes (or LEDs) configured to emit light in one or more wavelengths of the infrared spectrum. The infrared light source can also be dimmable for controlling an amount of infrared light provided in the enclosure 102. The lighting assembly 200 can further include an ultraviolet light source configured to emit light in one or more wavelengths of the ultraviolet spectrum. The ultraviolet light source can also be dimmable for controlling an amount of ultraviolet light provided in the enclosure 102.

In the illustrated embodiment, the roof 112 includes a vent 202 for allowing air to exit the enclosure 102. Specifically, the vent 202 is made of a mesh for allowing air and light, such as ultraviolet light emitted by the ultraviolet light source, to pass through while preventing organisms from exiting the enclosure 102. In one embodiment, the mesh is made of stainless steel and is 80% transparent. Alternatively, the mesh could be made of a different material and have a different transparency.

Still in the illustrated embodiment, the system 100 further includes a vertical growing assembly 150 disposed inside the enclosure 102. Specifically, the vertical growing assembly 150 is disposed on the rear wall 116a of the enclosure 102 and is adapted for receiving plants, fungus and/or similar organisms, as will be explained further below.

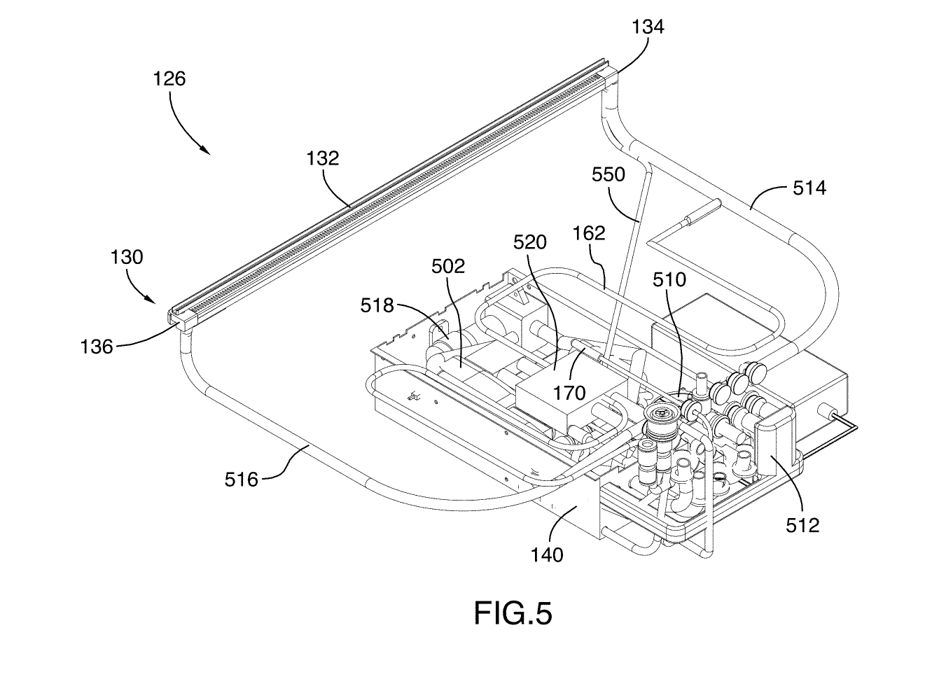

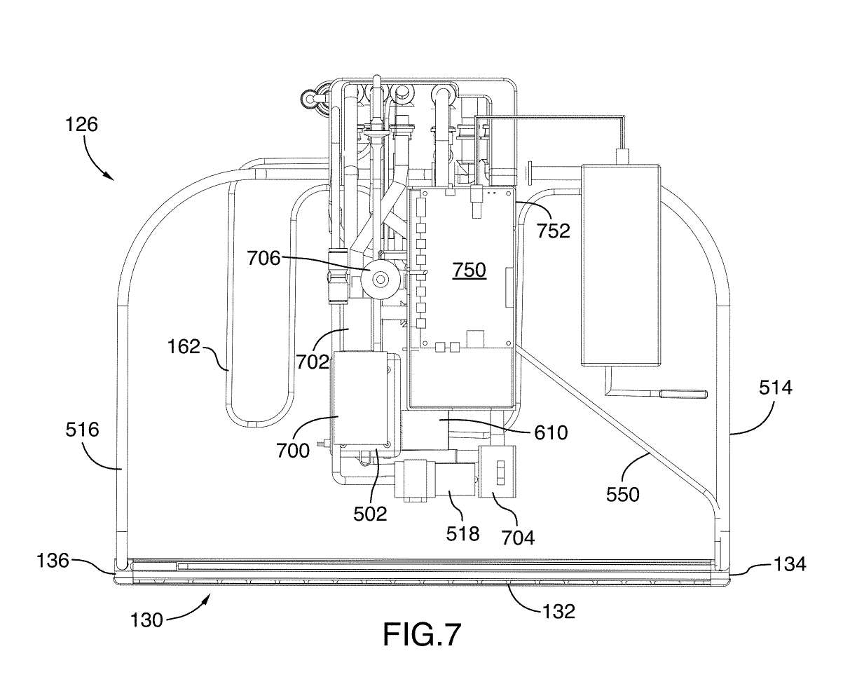

Now turning to FIGS. 5 to 7, the control assembly 126 includes an air pump 502 adapted to deliver air into the enclosure 102. Specifically, the control assembly 126 includes an air pump conduit 600 having a first end 602 operatively connected to the air pump 502 and a second end 604 adapted to be disposed inside the enclosure 102. In one embodiment, the second end 604 includes an airstone or a similar perforated termination submerged under water inside the enclosure 102 to generate air bubbles in the water in order to increase humidity inside the enclosure 102. The control assembly 126 could further include a valve, such as a check valve, to prevent water from inside the enclosure 102 from entering the air pump conduit 600 and/or reaching the air pump 502.

In the illustrated embodiment, the control assembly 126 further includes an air fan 510 for providing air from the exterior of the enclosure 102 to the ventilation strip 132. Specifically, the air fan 510 is operatively connected to a manifold 512 which simultaneously dispenses air to the ventilation strip 132 through a first manifold conduit 514 extending between the manifold 512 and the left end 134 of the ventilation strip 132 and through a second manifold conduit 516 extending between the manifold 512 and the right end 136 of the ventilation strip 132. The manifold 512 may further be sized and shaped to optimize airflow while minimizing back pressure. Alternatively, the control assembly 126 may not include a manifold and the air fan 510 could be directly connected to the ventilation strip 132 by a single conduit.

Still in the illustrated embodiment, the control assembly 126 further includes an air temperature control device operatively connected to the air fan 510 and/or the manifold 512 for controlling the temperature of the air provided by the air fan 510. Specifically, the air temperature control device includes a thermoelectric cooler/heater 700 disposed against the air fan 510. The thermoelectric cooler/heater 700 is located below the air fan 510 and is in contact with the air fan 510 to allow heat to be transferred from the thermoelectric cooler/heater 700 to the air in the air fan 510 or from the air in the air fan 510 to the thermoelectric cooler/heater 700 by conduction. Alternatively, the thermoelectric cooler/heater 700 could instead be disposed against the manifold 512, or even against one or both of the first and second manifold conduits 514, 516.

Still in the illustrated embodiment, the control assembly 126 further includes a water misting pump 518 which is adapted to deliver water from the water reservoir 128 at relatively high pressure into the enclosure 102 through a misting conduit 606. Specifically, the misting conduit 606 includes a first end 608 connected to the water misting pump 518 and a second end 204, shown in FIGS. 2 and 4, which is disposed inside the enclosure 102 near the roof 112. In the illustrated embodiment, the second end 204 of the misting conduit 606 includes a misting nozzle 206 adapted to provide mist inside the enclosure 102 according to a predetermined spray pattern. Alternatively, the misting nozzle 206 could be located as a different location inside the enclosure 102. In yet another embodiment, the control assembly 126 could be provided without a water misting pump 518, a misting conduit 606 and a misting nozzle 206.

In the illustrated embodiment, the control assembly 126 further includes an irrigation pump 702 operatively connected to the vertical growing assembly 150 for providing water to organisms in the vertical growing assembly 150, as will be explained further below.

Still in the illustrated embodiment, the control assembly 126 further includes a waterfall pump 704 operatively connected to a waterfall outlet 250, shown in FIG. 2, located inside the enclosure 102 near the roof 112. The waterfall outlet 250 is configured to allow water to flow towards the floor 114 of the enclosure 102 in a waterfall-like manner. In addition to providing an aesthetically pleasing effect, this configuration may contribute to the circulation of water within the enclosure 102. Alternatively, the system 100 may not comprise a waterfall pump 704 or a waterfall outlet 250.

In the illustrated embodiment, the control assembly 126 further includes a water cooler 610 which is operatively connected to both the irrigation pump 702 and the waterfall pump 704 for cooling the water dispensed by the irrigation pump 702 and the waterfall pump 704 into the enclosure 102. The water cooler 610 could include a thermoelectric cooler or any other type of cooler which a skilled person would deem to be suitable. In an alternative embodiment, the water cooler 610 could be connected only to one of the irrigation pump 702 and the waterfall pump 704. In yet another embodiment, the control assembly 126 could be configured without a water cooler.

In the illustrated embodiment, the control assembly 126 further includes a water recycling circuit operatively connected to the enclosure 102 and to the water reservoir 128 to recirculate water from the bottom of the enclosure 102 back into the enclosure 102. Specifically, the water recycling circuit includes a filter element 520 adapted to be disposed in the enclosure 102 on or near the floor 114 of the enclosure 102. The filter element 520 is at least partially submerged in water at the bottom of the enclosure 102 and is operatively connected to the irrigation pump 702 and to the waterfall pump 704 to allow the irrigation pump 702 and the waterfall pump 704 to filter water from the enclosure 102 by pumping the water through the filter element 520. The filter element 520 could include a sponge or any other type of device or material which would allow water to pass through while preventing debris from entering the irrigation pump 702 and the waterfall pump 704.

Still in the illustrated embodiment, the irrigation pump 702 is further operatively connected to the water reservoir 128 via a controllable valve 706 such as a solenoid valve. The controllable valve 706 allows water to be selectively directed by the irrigation pump 702 from the enclosure 102 back into the water reservoir 102.

Still referring to FIGS. 5 to 7, the control assembly 126 further includes a controller 750 operatively connected to the actuators of the control assembly 126 for controlling the actuators. Specifically, the controller 750 may be operatively connected to all or some of the air pump 502, the air fan 510, the thermoelectric cooler/heater 700, the water misting pump 518, the irrigation pump 702, the waterfall pump 704, the water cooler 610 and the controllable valve 706.

The controller 750 may further be operatively connected to the lighting assembly 200 of the system 100, and more specifically to the visible light source, to the infrared light source and to the ultraviolet light source.

In the illustrated embodiment, the controller 750 is further operatively connected to a first heating element 160 which is disposed inside the enclosure 102 on or near the floor 114. Specifically, the first heating element 160 includes a flexible first heating cable 162 which may be disposed in a generally serpentine pattern along the floor 114 of the enclosure 102. As shown in FIG. 1, the first heating cable 162 can extend through the raised platform 122 to provide heat to the raised platform 122 and to the substrate disposed on the raised platform 122. Alternatively, the first heating cable 162 could be disposed on the raised platform 122, in or below the substrate to heat the substrate directly by conduction. In yet another embodiment, the first heating cable 162 could be disposed under the raised platform 122. It will be further be appreciated that the first heating cable 162 could be at least partially submerged under water at the bottom of the enclosure 102. Instead of having a serpentine pattern, the first heating cable 162 could also be arranged according to a different pattern. It will be appreciated that the flexible heating cable 162 has a length and a power output which may be optimized to the area being heated, based for example on the size of the enclosure 102 and the type of substrate used. Alternatively, instead of a flexible heating cable, the first heating element 160 could instead be a rigid member having a predetermined shape.

Still in the illustrated embodiment, the controller 750 is further operatively connected to a second or ventilation heating element 550, best shown in FIG. 5, which extends along the ventilation strip 132 to provide heat to air circulating within the ventilation strip 132, as will be explained further below.

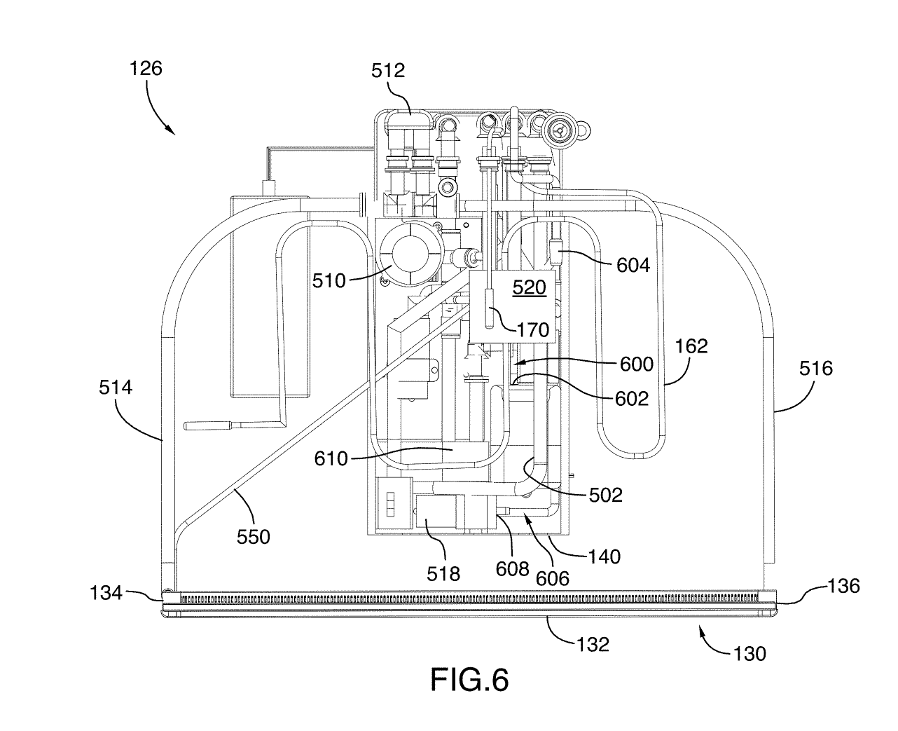

The controller 750 is further connected to first and second sensors 170, 172, best shown in FIG. 6, located within the enclosure 102. More specifically, the first sensor 170 is located near the floor 114 of the enclosure 102 and the second sensor 172 is located near the roof 112 of the enclosure 102. The first sensor 170 could further be secured on or inside the raised platform 122.

In the illustrated embodiment, each one of the first and second sensors 170, 172 is adapted to measure a plurality of parameters inside the enclosure 102. Specifically, the first sensor 170 is adapted to measure at least one of a water level inside the enclosure 102, a concentration of total dissolved solids in the water, a level of soil moisture and a substrate temperature. Similarly, the second sensor 172 is adapted to measure at least one of a level of infrared radiation, a temperature of the air inside the enclosure 102, a level of air quality inside the enclosure 102 and a level of humidity inside the enclosure 102. It will be understood that the first and second sensors 170, 172 could be configured to measure more or less parameters, or different parameters. Alternatively, the control assembly 126 could include only a single sensor or more than two sensors.

Still in the illustrated embodiment, the controller 750 is further connected to a camera 174 disposed within the enclosure 102 near the roof 112. The camera 174 is pointed towards the inside of the enclosure to capture images of the inside the enclosure 102 and transmitting the captured images to the controller 750. Alternatively, the camera 174 could be disposed outside of the enclosure 102 and be pointed at the enclosure 102 and positioned to capture images of the inside of the enclosure through the transparent front wall 116b or lateral walls 116c, 116d.

In the illustrated embodiment, the controller 750 includes a printed circuit board or PCB defining a processing unit and a communication unit operatively connected to the processing unit.

The processing unit is adapted to receive measurement data from the sensors 170, 172, while the communication unit allows communication between the controller 750 and a remote server, not shown, to allow data to be transferred between the controller 750 and the remote server, as will be explained further below.

The processing unit may also be configured for receiving measurement data from the first and second sensors 170, 172 and from the camera 174 and to transmit the measurement data to the remote server via the communication unit.

The communication unit may also be adapted for receiving one or more instructions from the remote server and the processing unit may be adapted for receiving the one or more instructions from the communication unit and for actuating one or more of the actuators according to the instructions received, as will be explained further below.

The processing unit may also be configured for receiving measurements data from the first and second sensors 170, 172 and from the camera 174 and for actuating one or more of the actuators according to the measurement data without requiring the use of the communication unit, as will also be further explained below.

In one embodiment, the controller 750 may further include a memory operatively connected to the processing unit for storing measurement data received from the first and second sensors 170, 172 and from the camera 174. The memory could further be used to store target values which could be compared by the processing unit to the measurement data measured by the first and second sensors 170, 172 and from the camera 174.

Still in the illustrated embodiment, the actuators and the controller 750 are operatively connected to a power source for powering the actuators and the controller. Specifically, the controller 750 is operatively connected to an AC adapter adapted to be connected to a power outlet to provide DC current to the controller 750, which in turn powers the actuators and/or the sensors 170, 172 and the camera 174. Alternatively, the AC adapter could be directly connected to the controller 750 as well as to the actuators and to the sensors 170, 172 and to the camera 174.

Still referring to FIGS. 5 to 7, the controller 750 is housed in a controller casing 752 which is located inside the housing 140. The controller casing 752 is waterproof and is adapted to protect the controller 750 from water and humidity.

In the illustrated embodiment, the housing 140 is made of sheet metal and is adapted to protect organisms inside the enclosure 102 from radiation having a predetermined wavelength or frequency emitted by the controller 750 and/or the actuators located inside the housing 140. Specifically, the housing 140 is configured such that a maximum size of an opening defined in the housing 140 is smaller than the predetermined wavelength to thereby prevent radiation having a wavelength equal to or greater than the predetermined wavelength are prevented from exiting the housing 140. In one embodiment, the predetermined wavelength is between 0.3 cm and 400 cm.

It will be further appreciated that although a specific arrangement is illustrated in FIGS. 5 to 7, the tubes and conduits may be arranged according to configurations that are different from the configuration shown in FIGS. 5 to 7.

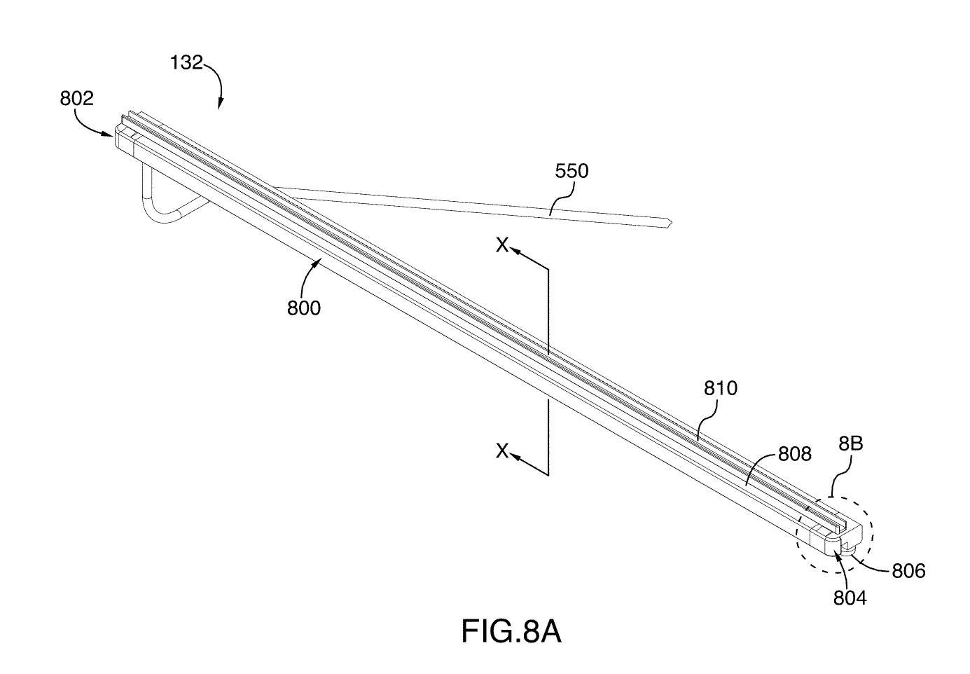

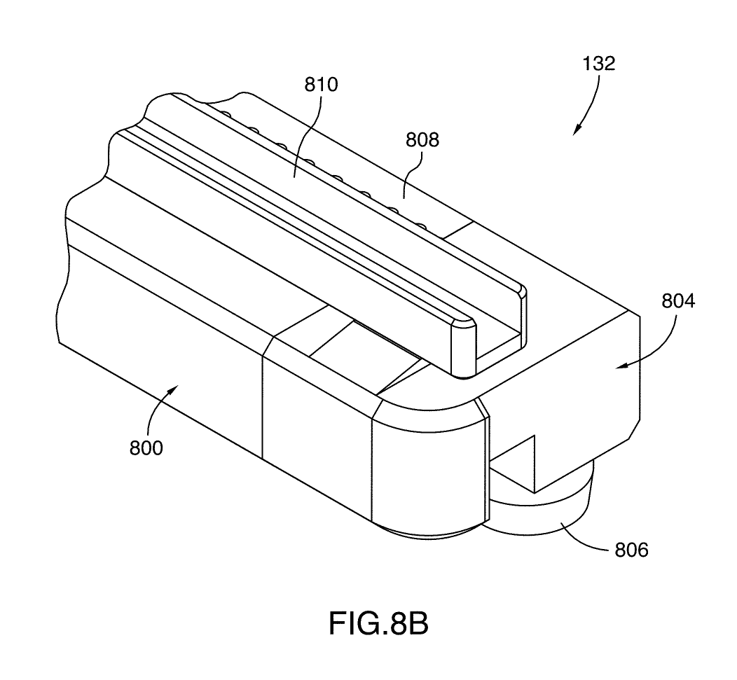

Referring now to FIGS. 8A to 13, the ventilation strip 132 includes an elongated central body 800 and left and right end caps 802, 804, each one being respectively disposed at the left and right ends 134, 134 of the ventilation strip 132. Each one of the left and right end caps 802, 804 includes an inlet 806 which is adapted to be connected to a respective one of the left and right manifold conduits 514, 516.

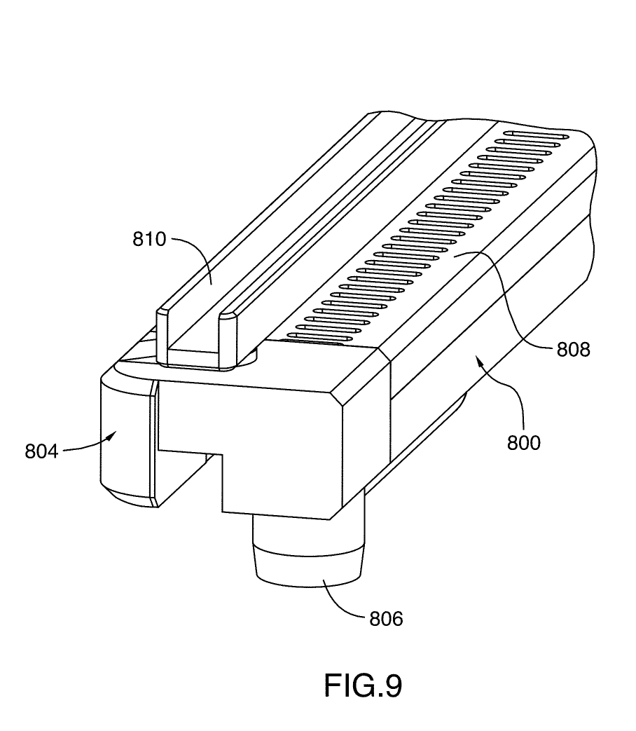

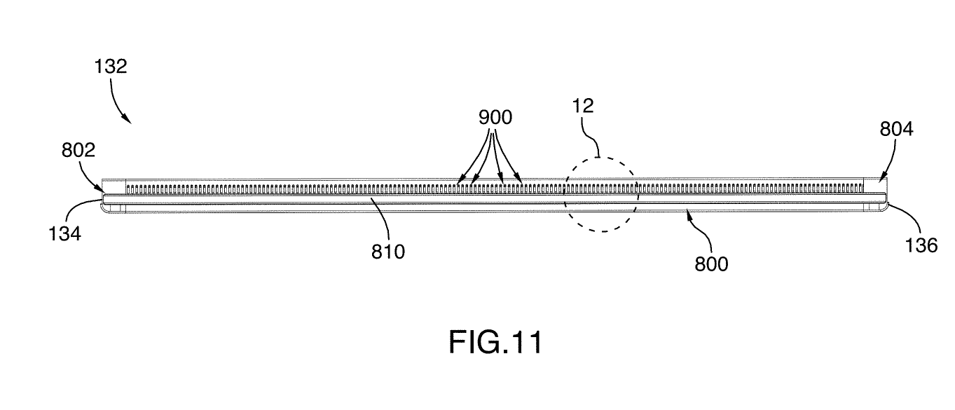

In the illustrated embodiment, the central body 800 has a top face 808 which is generally planar. As best shown in FIGS. 9 and 11, the ventilation strip 132 is hollow and includes a plurality of ventilation openings 900 defined in the top face 808 of the central body 800. The ventilation openings 900 are spaced apart from each other and are distributed generally evenly along the top face 808 of the central body 800 between the left and right end caps 802, 804.

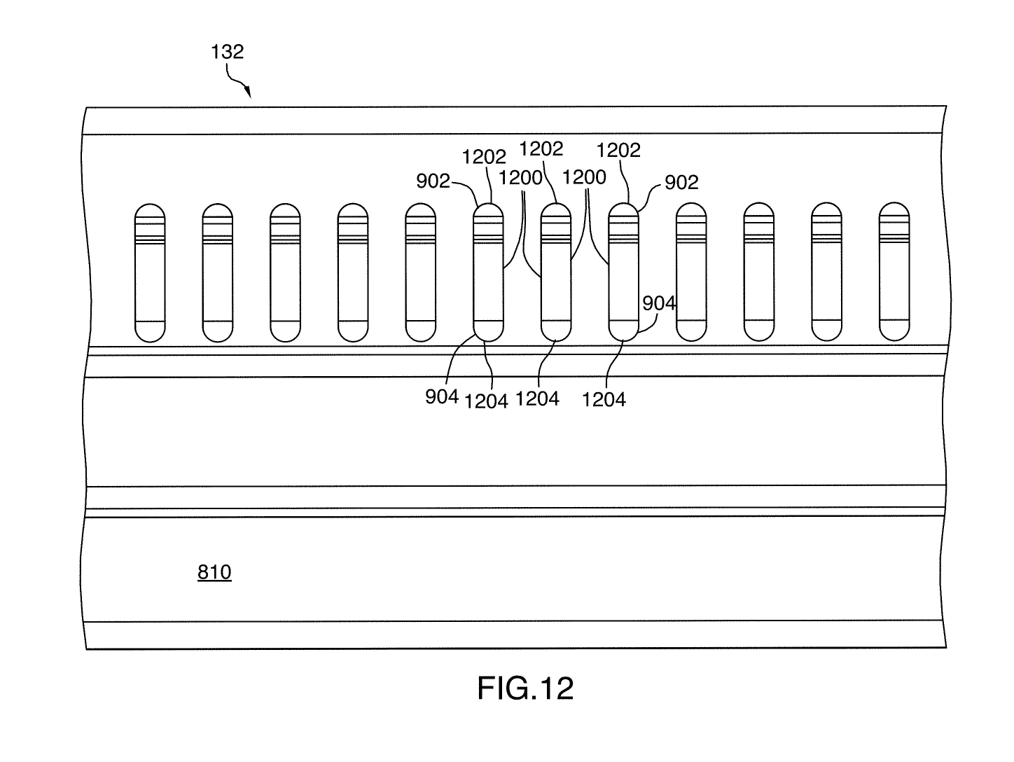

Each ventilation opening 900 is elongated and extends transversely relative to the ventilation strip 132. Specifically, each ventilation opening 900 has a first end 902 located towards the interior of the enclosure 102 and a second end 904 located opposite the first end 902. As best shown in FIG. 12, each ventilation opening 900 is generally oblong and is defined by a pair of parallel straight side edges 1200 and first and second semicircular end edges 1202, 1204 extending between the side edges 1200. Specifically, the first semicircular edge 1202 is disposed at the first end 902 of the ventilation opening 900, towards the interior of the enclosure 1204, and the second semicircular edge 102 is disposed at the second end 904 of the ventilation opening 900, towards the exterior of the enclosure 102.

In the illustrated embodiment, the front wall 116b includes a bottom track 810 disposed on the ventilation strip 132 for receiving the upper front wall panel 118. The bottom track 810 is therefore in vertical alignment with the front wall 116b. As best shown in FIGS. 9 and 11, the ventilation openings 900 are located inside the enclosure 102 when the ventilation strip 132 is installed between the upper front wall panel 118 and the lower front wall panel 120.

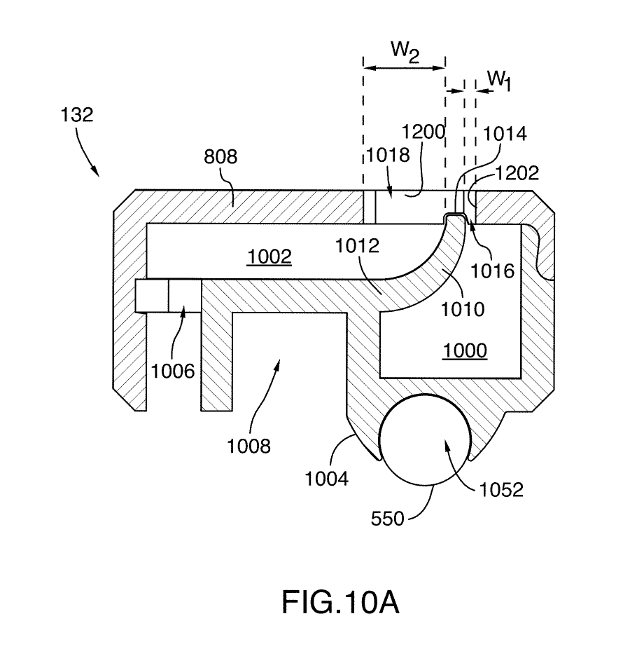

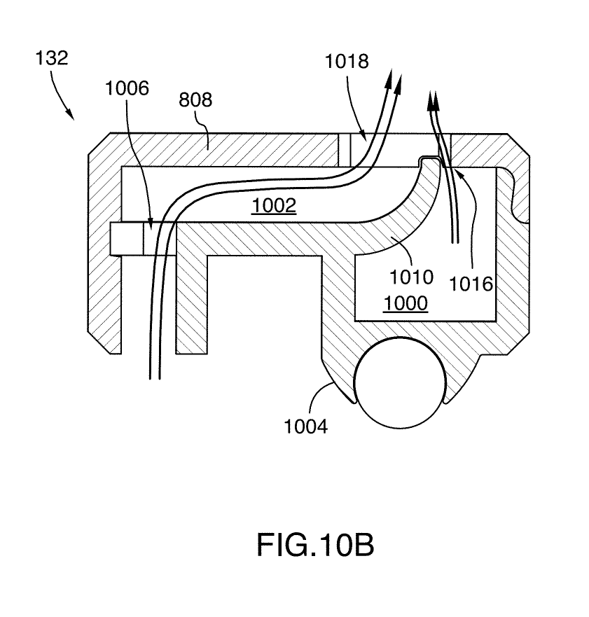

Referring specifically to FIGS. 10A and 10B, the central body 800 defines a first inner channel 1000, as shown in FIG. 10, which extends longitudinally between the left and right ends 134, 136 of the ventilation strip 132. The first inner channel 1000 is in communication with the air fan 510 which dispenses air into the first inner channel 1000 through the left and right manifold conduits 514, 516, as described above. The first inner channel 1000 is also in communication with the ventilation openings 900 and thereby allows air from the air fan 510 to flow into the enclosure 102.

As further shown in FIGS. 10A and 10B, the central body 800 further includes a second inner channel 1002 which is adjacent the first inner channel 1000. The second inner channel 1002 is in communication with the exterior of the enclosure 102 and allows air from the exterior of the enclosure 102 to be dispensed through the ventilation openings 900.

Still referring to FIGS. 10A and 10B, the ventilation strip 132 further includes a bottom face 1004 which is located opposite the top face 808. A plurality of inlet openings 1006 are defined in the bottom face 1004. The plurality of inlet openings 1006 allow communication between the second inner channel 1002 and the exterior of the enclosure 102.

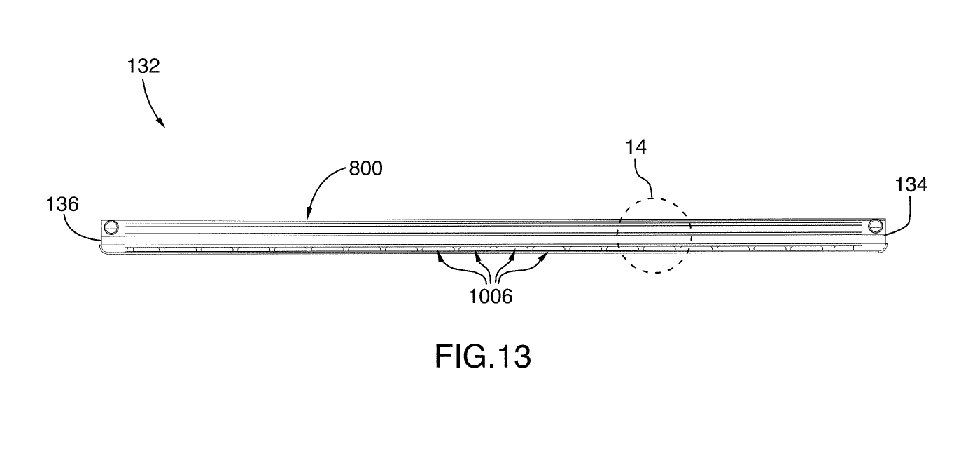

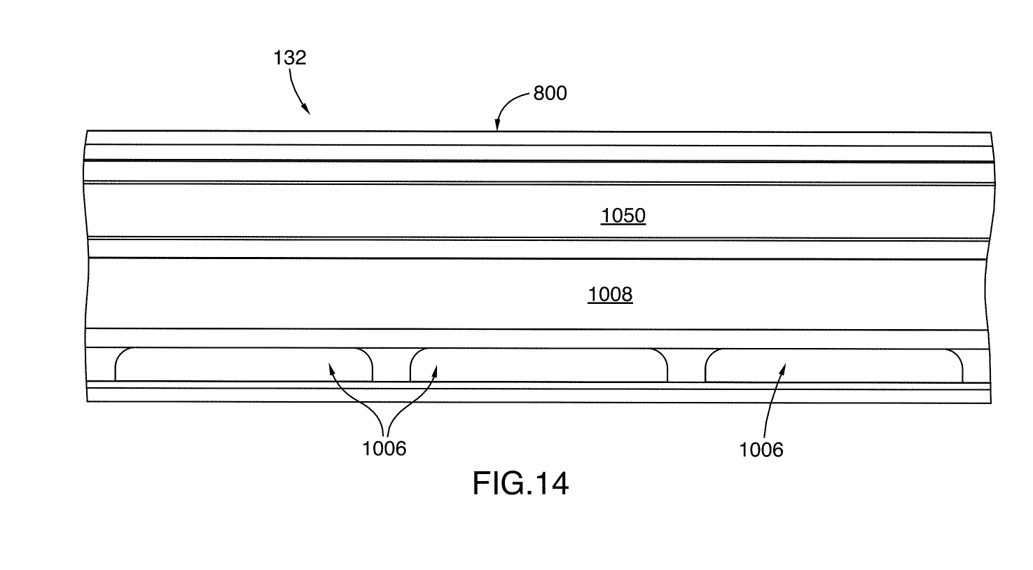

Turning to FIGS. 13 and 14, the inlet openings 1006 are spaced apart from each other and are distributed generally evenly between the left and right ends 134, 136 of the ventilation strip 132. It will be appreciated that although the inlet openings 1006 include a plurality of discrete openings, the ventilation strip 132 could instead include a single, elongated inlet opening allowing communication between the second inner channel 1002 and the exterior of the enclosure 102.

Turning back to FIGS. 10A and 10B, the bottom face 1004 further includes a panel receiving recess 1008 extending longitudinally between the left and right ends 134, 136 of the ventilation strip 132. The panel receiving recess 1008 is sized and shaped to receive a top edge of the lower front wall panel 120.

Still referring to FIGS. 10A and 10B, the ventilation strip 132 further includes a curved inner fin 1010 which extends between the first and second inner channels 1000, 1002. Specifically, the curved inner fin 1010 extends away from the second inner channel 1002 and is convex towards the first inner channel 1000.

The curved inner fin 1010 includes a base end 1012 secured to the bottom face 1004 of the ventilation strip 132 and a free end 1014 opposite the base end 1012. In the illustrated embodiment, the curved inner fin 1010 tapers slightly from the base end 1012 to the free end 1014.

Specifically, the free end 1014 of the curved inner fin 1010 abuts the top face 808 below the ventilation openings 900 to divide each ventilation opening 900 into a first opening portion 1016 allowing communication between the first inner channel and the interior of the enclosure 102 and a second opening portion 1018 allowing communication between the second inner channel 1002 and the interior of the enclosure 102.

As shown in FIGS. 10A and 10B, the second opening portion 1018 has a width W₂ which is larger than the width W₁ of the first opening portion 1016. Specifically, the free end 1014 of the curved inner fin 1010 is disposed between the straight side edges 1200 and the first semicircular end edge 1202 such that the first opening portion 1016 is defined between the free end 1014 of the curved inner fin 1010 and the first semicircular end edge 1202.

In this configuration, the air fan 510 creates a flow of air in the first inner channel 1000, as shown in FIG. 10B. The air accelerates as it exits the first inner channel 1000 through the first opening portion 1016 which has a relatively small area. This creates a low pressure zone at or above the ventilation opening 900, a phenomenon known as the “Venturi effect”, which draws air into the enclosure 102 from the second inner channel 1002 and from the exterior of the enclosure 102 through the inlet openings 1006. It will be understood that this configuration allows an increased flow of fresh air to be introduced into the enclosure 102 through the second inner channel 1002 and the inlet openings 1006.

It will be appreciated that if the enclosure was provided without the ventilation strip 132 and fresh air was only provided in the enclosure 102 using the air fan 510, additional power would need to be provided to the air fan 510 in order to allow the air fan 510 to generate the same air flow as the ventilation strip 132 provides. The present configuration may therefore lower the energy consumption and the cost associated with the use of the system 100.

In the illustrated embodiment, the ventilation heating element 550 extends longitudinally along the central body 800 of the ventilation strip 132. As shown in FIG. 10, the ventilation heating element 550 is disposed adjacent the first inner channel 1000 to provide heat to air circulating in the first inner channel 1000. Specifically, the ventilation heating element 550 has a cylindrical cross-section and the bottom face 1004 of the ventilation strip 132 includes a heating element recess 1052 having a corresponding cylindrical cross-section for receiving the ventilation heating element 550. In the illustrated embodiment, the ventilation heating element 550 includes a heating cable, but the ventilation heating element 550 could alternatively include a rigid heating member.

It will be appreciated that the heated air will continue to rise vertically inside the enclosure 102 once it exits the ventilation strip 132 and will therefore heat the upper front wall panel 118 located above the ventilation strip 132, thereby preventing the formation of condensation on the upper front wall panel 118.

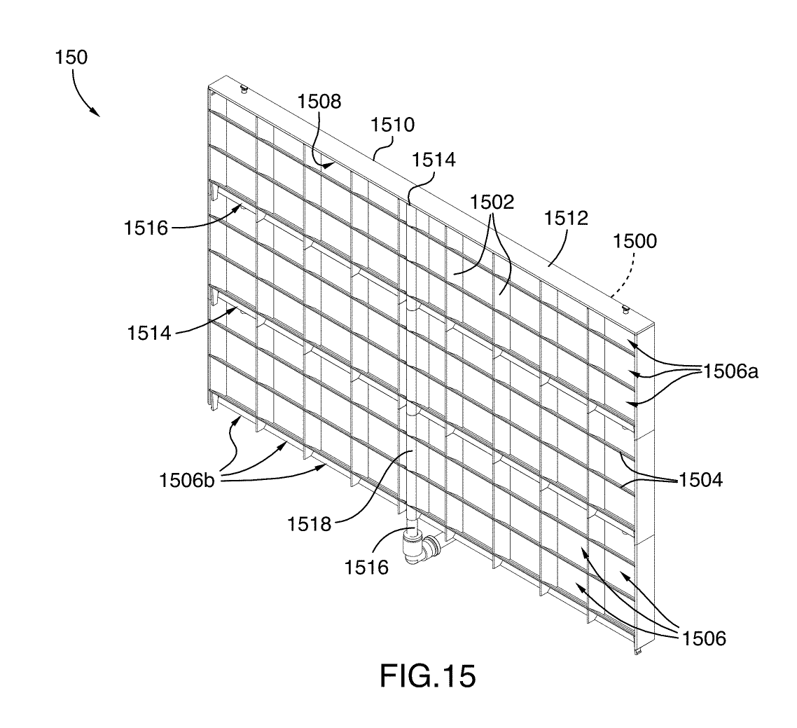

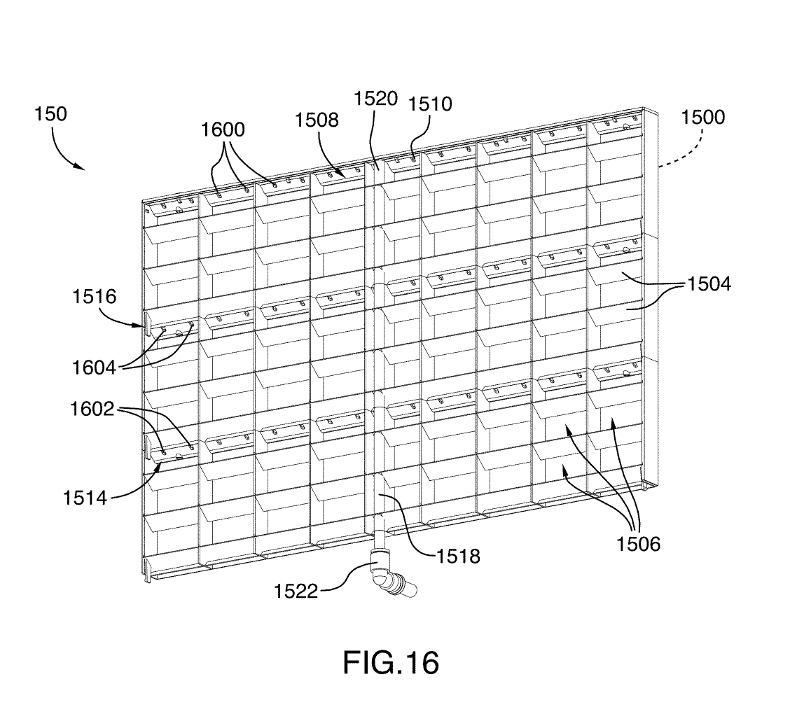

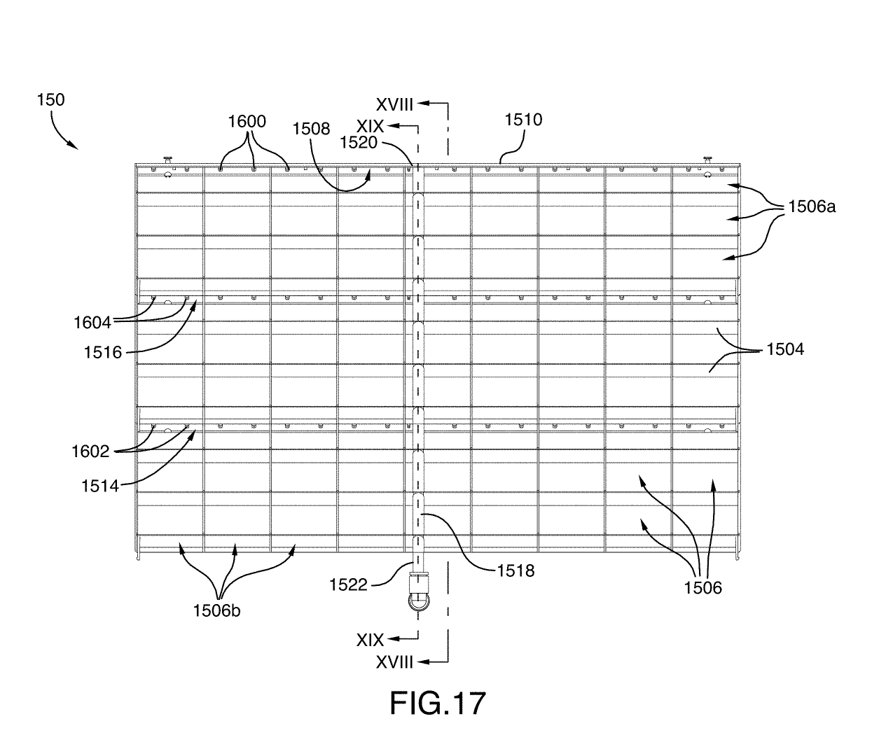

Now referring to FIGS. 15 to 19, the vertical growing assembly 150 includes a mounting panel 1500 disposed vertically against the rear wall 116a, a plurality of spaced-apart vertical bar members 1502 which extend from the mounting panel 1500 into the enclosure 102, towards the front wall 116c, and a plurality of diagonal slats 1504 angled upwardly relative to the mounting panel 1500 and extending between the vertical bar members 1502.

In this configuration, the diagonal slats 1504 and the vertical bar members 1502 define an array of rectangular cells 1506 on the mounting panel 1500. The cells 1506 are adapted to receive a substrate or any other substance for growing one or more organism such as a plant or a fungus. In the illustrated embodiment, the array of rectangular cells 1506 defines a grid pattern and includes nine rows 1506a and nine columns 1506b. Alternatively, the array of rectangular cells 1506 could include a different number of rows and columns 1506a, 1506b.

In the illustrated embodiment, the vertical growing assembly 150 further includes a top water distribution member 1508 disposed at a top end 1510 of the mounting panel 1500. The top water distribution member 1508 is generally straight and extends substantially along the entire width of the mounting panel 1500 above the array of rectangular cells 1506. In the illustrated embodiment, the top water distribution member 1508 is generally configured like a trough and defines an open channel. The top water distribution member 1508 further includes a top cap 1512 which can be placed over the top water distribution member 1508 to close off the top water distribution member 1508. Specifically, the top cap 1512 may include a substantially flat and elongate sheet of material adapted to be placed over the top water distribution member 1508. Alternatively, the top water distribution member 1508 could instead include a closed conduit such as a tube instead of an open conduit.

The top water distribution member 1508 is adapted to receive water and to distribute water to the cells 1506 below. Specifically, the top water distribution member 1508 includes a plurality of top drip holes 1600 to allow water from the top water distribution member 1508 to flow or drip down towards the diagonal slats 1504. In the illustrated embodiment, the plurality of top drip holes 1600 includes two top drip holes in vertical alignment with each column 1506b of the array of rectangular cells 1506, for a total of 18 top drip holes 1600.

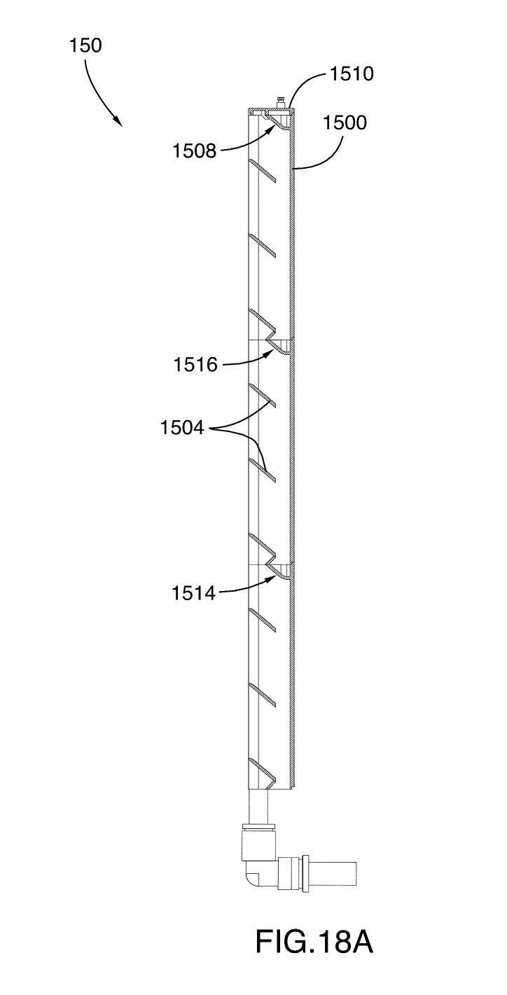

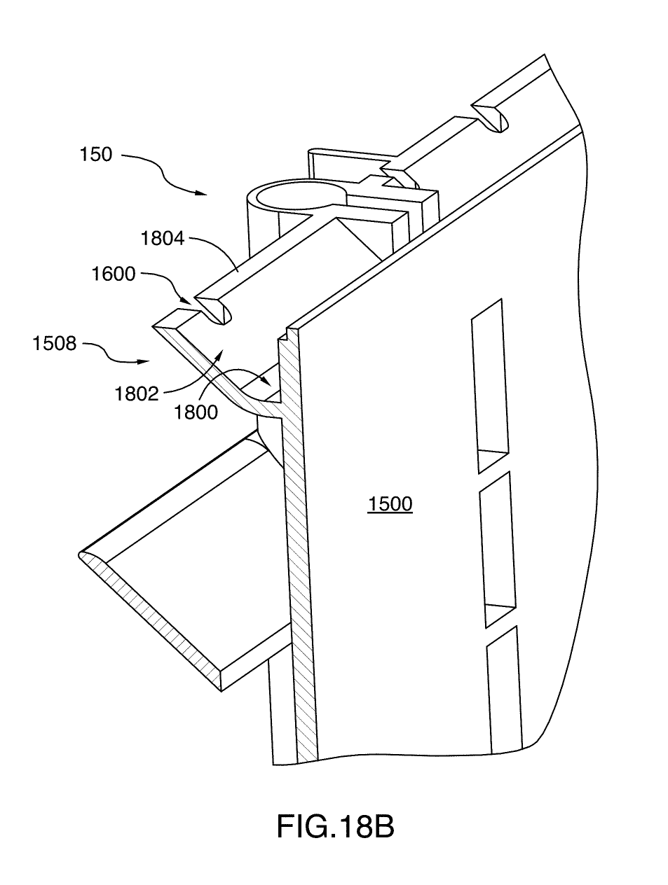

As best shown in FIG. 18A, the top water distribution member 1508 includes a bottom portion 1800 connected to the mounting panel 1500, a front portion 1802 which is angled away from the mounting panel 1500 and defines an upper horizontal edge 1804 located away from the mounting panel 1500. The top drip holes 1600 are defined as indents in the upper horizontal edge 1804 and extend in the front portion 1802, but remain spaced from the bottom portion 1800. In this configuration, water accumulates on the bottom portion 1800 until the water level rises and reaches the top drip holes 1600 and then flows or drips downwardly through the top drip holes 1600. This allows water to be distributed evenly along the top water distribution member 1508 before flowing or dripping downwardly to water the organisms in the cells 1506 below.

Moreover, each top drip hole 1600 can be partially or fully blocked by an adjustable stopper, not shown, which can be manually installed and adjusted according to the watering needs of the organism in a particular cell 1506. In one embodiment, the adjustable stopper includes a plug which can be received in the top drip hole 1600 to completely prevent water from flowing or dripping through the top drip hole 1600. Alternatively, the adjustable stopper could be configured to allow the area of the top drip holes 1600 to be selectively reduced to thereby reduce flow of water through the top drip holes 1600 accordingly. This configuration allows the top water distribution member 1508 to be configured such that water flows through each top drip hole 1600 at a flow or drip rate which is appropriate for the organism received in the cells 1506 in the column 1506b below the top drip hole 1600. This allows different organisms with different watering needs to be placed in the different cells 1506 of a common row 1506a.

Referring now specifically to FIG. 18, the diagonal slats 1504 are horizontally spaced from the mounting panel 1500. This configuration enables water to trickle or flow down to rows 1506a of cells 1506 below. It will be understood that the substrate received in the cells 1506 is sufficiently compacted and/or moist to be able to remain within the cell 1506 and not fall through towards the cells 1506 below. Alternatively, a mesh or another similar perforated surface could be provided at the bottom of the cell 1506, extending between the diagonal slat and the mounting panel 1500, to assist in keeping the substrate within the cell 1506 while allowing water to drip or flow through.

In the illustrated embodiment, the vertical growing assembly 150 further includes a bottom water distribution member 1514 and an intermediate water distribution member 1516 located between the top water distribution member 1508 and the bottom water distribution member 1514. Specifically, the intermediate water distribution member 1516 is disposed between the diagonal slats 1504 of the third row 1506a of cells 1506 from the top end 1510 of the mounting panel 1500 and thereby defines a bottom of the third row 1506a. Similarly, the bottom water distribution member 1514 is disposed between the diagonal slats 1504 of the sixth row 1506a of cells 1506 from the top end 1510 of the mounting panel 1500 and thereby defines a bottom of the sixth row 1506a. Alternatively, the bottom and intermediate water distribution members 1514, 1516 could be located at different vertical locations on the vertical growing assembly 150. In another embodiment, the vertical growing assembly may include only one of the bottom and intermediate water distribution members 1514, 1516, additional water distribution members or even no water distribution member at all below the top water distribution assembly 1508.

Still in the illustrated embodiment, the bottom and intermediate water distribution members 1514, 1516 are generally similar to the top water distribution member 1508. The bottom water distribution member 1514 and the intermediate water distribution member 1516 respectively include a plurality of bottom and intermediate drip holes 1602, 1604 similar to the top drip holes 1600 of the top trough 1508. Similar to the top water distribution member 1508, the bottom and water distribution members 1514, 1516 are configured such that water accumulates and is distributed along the entire length of the bottom and intermediate water distribution members 1514, 1516 before the water level reaches the corresponding drip holes 1602.

Similarly to the top drip holes 1600, the bottom and intermediate drip holes 1602, 1604 can also be partially or fully blocked by an adjustable stopper, not shown, which can be manually installed and adjusted. It will be appreciated that the top, bottom and intermediate drip holes 1600, 1602, 1604 of a common column 1506b can be adjusted so as to provide water at different flow or drip rates. For example, in a same column 1506b, water could be dispensed from the top drip holes 1600 to the cells 1506 between the top water distribution member 1508 and the intermediate water distribution member 1516 at a first flow or drip rate, from the intermediate drip holes 1604 to the cells 1506 between the intermediate water distribution member 1516 and the bottom water distribution member 1514 at a second flow or drip rate different from the first flow or drip rate, and from the bottom drip holes 1602 downwardly at a third flow or drip rate different from the first and second flow or drip rates. This configuration therefore allows different organisms with different watering needs to be disposed according to various arrangements in the cells 1506. Alternatively, all flow or drip rates in a same column could be similar.

In the illustrated embodiment, the vertical growing assembly 150 further includes a vertical irrigation pipe 1518 having an upper end 1520 operatively connected to the top water distribution member 1508 and a lower end 1522 operatively connected to the irrigation pump 702 for dispensing water through the vertical irrigation pipe 1518 and into the top water distribution member 1508.

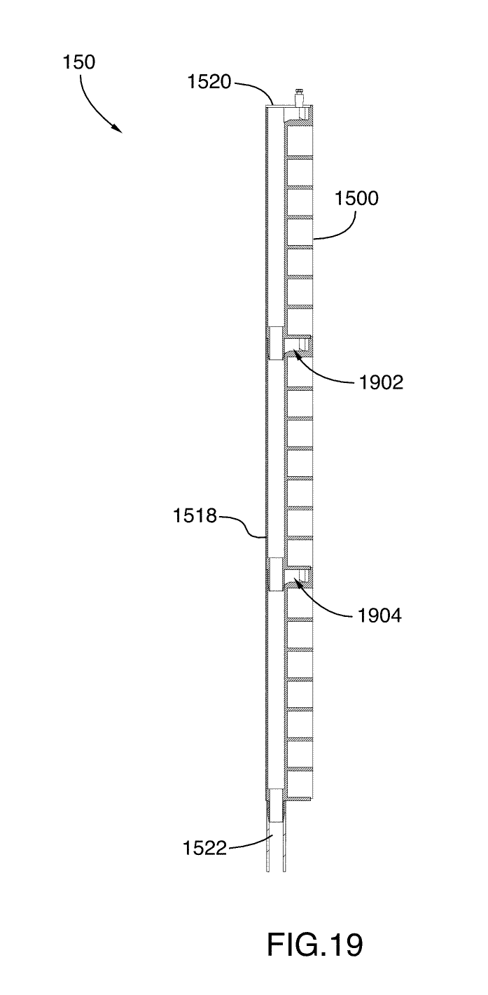

In the illustrated embodiment, the vertical irrigation pipe 1518 extends in one of the columns 1506b through the corresponding diagonal slats 1504 and the bottom and intermediate water distribution members 1514, 1516. The vertical irrigation pipe 1518 is secured to the mounting panel 1500 by a mounting bracket 1900 which spaces the vertical irrigation pipe 1518 from the mounting panel 1500, as best shown in FIG. 19.

In the illustrated embodiment, the mounting bracket 1900 is generally continuous along the mounting panel 1500, but includes intermediate and bottom communication openings 1902, 1904 which are horizontally aligned respectively with the intermediate and bottom water distribution members 1516, 1514 to allow communication within the water distribution members 1516, 1514 through the mounting bracket 1900.

In operation, water is provided through the vertical irrigation pipe 1518 to the top water distribution member 1508. Water is distributed substantially evenly along the length of the top water distribution member 1508 and the water level rise until the water level is at or above the top drip holes 1600. Water then flows or drips down from the top drip holes 1600 towards the cells 1506 below. It will be appreciated that the diagonal slats 1504, being angled, redirect water from above towards the mounting panel 1500. The water continues to flow or drip down until it reaches the intermediate water distribution member 1516. Water then accumulates in the intermediate water distribution member 1516 and the water level rises until the water level is at or above the intermediate drip holes 1606. Water then flows or drips down from the intermediate drip holes 1606 towards the cells 1506 below. The water continues to flow or drip down until it reaches the bottom water distribution member 1514. Water then accumulates in the bottom water distribution member 1514 and the water level rises until the water level is at or above the bottom drip holes 1604. Water then flows or drips down from the bottom drip holes 1604 towards the cells 1506 below, and then back towards the bottom of the enclosure 102. It will be appreciated that the substrate and organisms on the vertical growing assembly 150 act as a biological filter to filter water which is then returned into the system 100.

In the illustrated embodiment, the vertical growing assembly 150 is made of a plurality of identical subsections 1550a, 1550b, 1550c stacked vertically. Specifically, the vertical growing assembly 150 includes an upper subsection 1550a which includes the top water distribution member 1508 and extends downwardly to the intermediate water distribution member 1516, an intermediate subsection 1550b which includes the intermediate water distribution member 1516 and which extends downwardly to the bottom water distribution member 1514, and a lower subsection which includes the bottom water distribution member 1514 and which extends downwardly therefrom.

It will be appreciated that providing the vertical growing assembly 150 in separate, stackable subsections allows the vertical growing assembly 150 to be re-sized depending on the size of the enclosure 102 in which the vertical growing assembly 150. For example, to use the illustrated vertical growing assembly 150 in a shorter enclosure, the lower subsection 1550c could simply be removed. If the vertical growing assembly 150 is to be used in a taller enclosure, one or more additional subsection could be added. It will further be appreciated that providing the vertical growing assembly 150 in identical subsections reduces the costs associated with the manufacturing of the vertical growing assembly. Alternatively, the vertical growing assembly 150 could be manufactured in a single unitary piece.

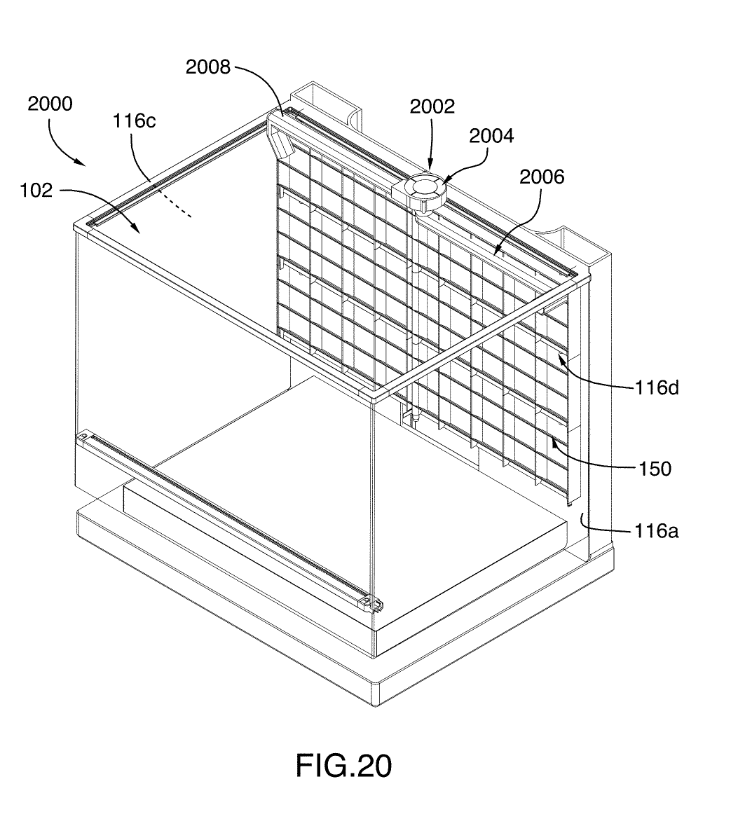

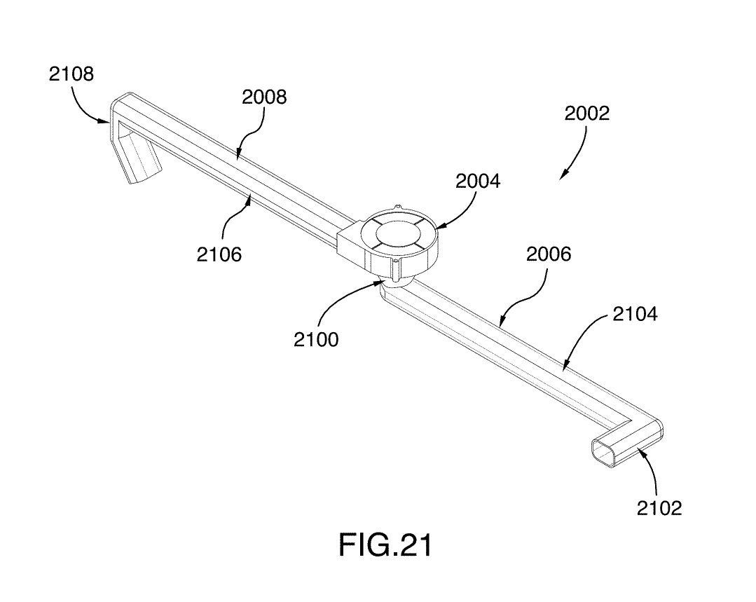

Now turning to FIGS. 20 to 23, there is shown a system 2000 for mimicking the environmental conditions of a habitat, in accordance with an alternative embodiment. The system 2000 is substantially similar to the system 100 illustrated in FIGS. 1 to 19, but further includes an internal airflow assembly 2002 disposed inside the enclosure 102 to create an internal airflow within the enclosure 102. It will be appreciated that an airflow within the enclosure 102 may contribute in increasing the net photosynthetic rate of plants inside the enclosure 102.

Specifically, the internal airflow assembly 2002 includes an airflow fan 2004 and inlet and outlet conduits 2006, 2008 extending away from the airflow fan 2004. The inlet and outlet conduits 2006, 2008 are in communication with the airflow fan 2004 to allow the airflow fan 2004 to draw air from inside the enclosure 102 through the inlet conduit 2006 and to expel air back into the enclosure 102 through the outlet conduit 2008, thereby creating an airflow throughout the enclosure 102.

In the illustrated embodiment, the inlet conduit 2006 extends away from the airflow fan 2004 towards the right lateral wall 116d and the outlet conduit 2008 extends towards the left lateral wall 116c.

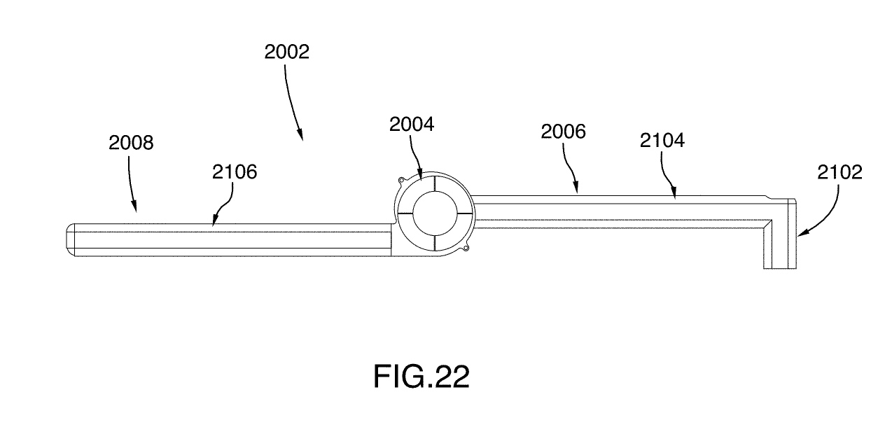

The inlet conduit 2006 includes a first end portion 2100 connected to the airflow fan 2004, a second end portion 2102 which is located away from the airflow fan 2004 and near the right lateral wall 116d, and a generally straight central portion 2104 extending between the first and second end portions 2100, 2102. When viewed from above, the second end portion 2102 and the central portion 2104 define an L-shaped configuration, as best shown in FIG. 22. Specifically, the central portion 2104 extends in a first vertical plane, and the second end portion 2102 extends away from the first vertical plane, towards the inside of the enclosure 102, at an angle of about 90 degrees from the central portion 2104. In the illustrated embodiment, the second end portion 2102 is generally straight and has a length of about 25 mm. Alternatively, the second end portion 2102 could be angled from the central portion 2104 by a different angle. In yet another embodiment, instead of a central portion and a second end portion which is distinct from the central portion, the inlet conduit 2006 could instead include a single curved portion which extends away from the first end portion 2010.

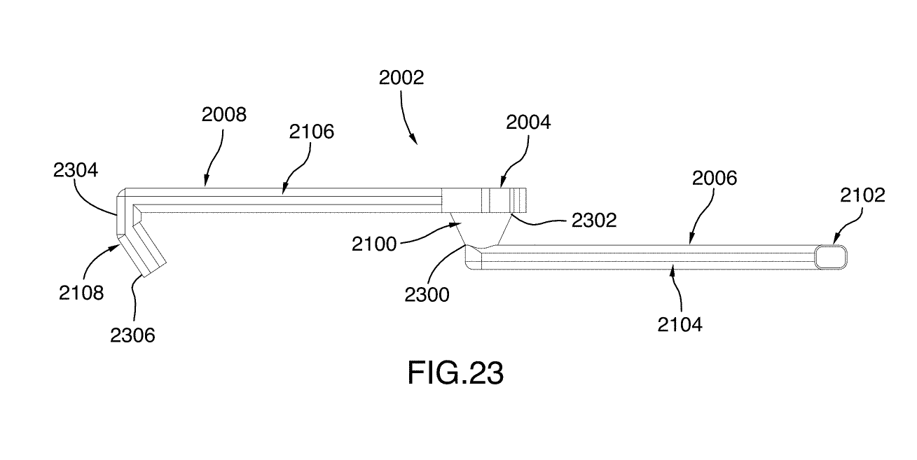

In the illustrated embodiment, the first end portion 2100 is generally tapered or funnel-shaped, as best shown in FIG. 23, and extends upwardly from the central portion 2104. Specifically, the first end portion 2100 includes a lower end 2300 which has a first diameter and an upper end 2302 which has a second diameter larger than the first diameter. The second diameter is sized and shaped to be connected to an inlet of the airflow fan 2004, and the first diameter corresponds generally to a width of the central portion 2014. Alternatively, the inlet conduit 2006 may not include a first end portion and the central portion 2014 may instead be connected directly to the airflow fan 2004.

Still referring to FIGS. 20 to 23, the outlet conduit 2008 includes a main portion 2106 which is connected to the airflow fan 2004 and an end portion 2108 which is located near the left lateral wall 116c. Specifically, the main portion 2106 is straight and extends in a first horizontal plane, and the end portion 2108 extends downwardly from the first horizontal plane. In the illustrated embodiment, the end portion 2108 includes a vertical segment 2304 and an angled segment 2306, best shown in FIG. 23, extending from the vertical segment 2304 downwardly and towards the right lateral wall 116d of the enclosure 102. Alternatively, instead of a vertical segment and an angled segment, the end portion 2108 of the outlet conduit 2008 could instead include a single curved portion which extends downwardly from the main portion 2106. In yet another embodiment, instead of a main portion and an end portion, the outlet conduit 2008 could include a single curved portion which extends away from the airflow fan 2004.

In the illustrated embodiment, both the inlet and outlet conduits 2006, 2008 have a generally rectangular cross-sectional shape. Alternatively, the inlet and outlet conduits 2006, 2008 could have a different cross-sectional shape. It will also be understood that depending on the configuration of the airflow fan 2004, the inlet and outlet conduits 2006, 2008 could be shaped differently.

In the illustrated embodiment, the internal airflow assembly 2002 is located near the roof 112, not shown in FIGS. 20 to 23, and the rear wall 116a of the enclosure 102. In one embodiment, the vertical growing assembly 150 may include a recess, not shown, to receive the internal airflow assembly 2002. Alternatively, the internal airflow assembly 2002 may be disposed such that the airflow fan 2004 is located above the vertical growing assembly 150 or in front of the vertical growing assembly 150.

To secure the internal airflow assembly 2002 inside the enclosure 102, one or more of the airflow fan 2004, the inlet conduit 2006 and the outlet conduit 2008 could be secured to the rear wall 116a, the left lateral wall 116c, the right lateral wall 116d, the roof 112 and/or the vertical growing assembly 150 using fasteners such as screws or the like. Alternatively, the internal airflow assembly 2002 could include mounting brackets which could be configured for mounting the internal airflow assembly 2002 inside the enclosure 102 near the roof 112.

In the configuration described above, the inlet conduit 2006 and the outlet conduit 2008 are located on opposite sides of the airflow fan 2004 and near opposite sides of the enclosure 102. Furthermore, the second end portion 2102 of the inlet conduit 2006 and the end portion 2108 of the outlet conduit 2008 are angled relative to each other. Specifically, the second end portion 2102 of the inlet conduit 2006 is generally horizontal while the end portion 2108 of the outlet conduit 2008 is generally angled downwardly. It will be appreciated that this configuration generally contributes to creating an air flow throughout the entire enclosure 102 rather than only in part of the enclosure.

Alternatively, the internal airflow assembly 2002 could instead be disposed near the left or right lateral walls 116, 116d of the enclosure 102 such that the inlet and outlet conduits 2006, 2008 extend towards the rear and front walls 116a, 116b. In yet another embodiment, the inlet and outlet conduits 2006, 2008 could be disposed according to one of various alternative configurations and have one of various alternative shapes.

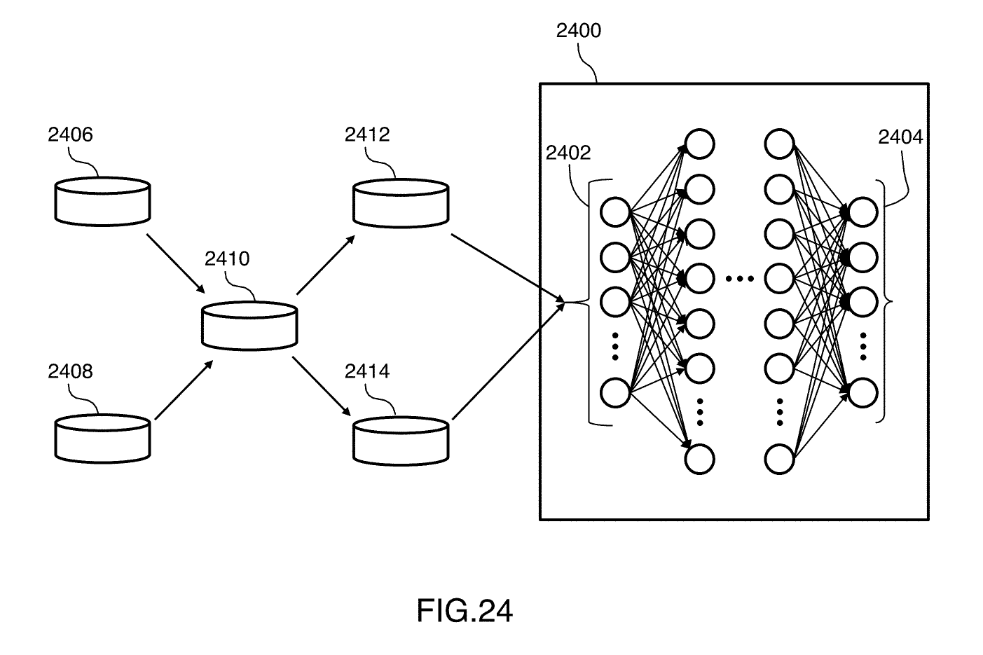

Now turning to FIG. 24, operation of the system 100 will now be described, in accordance with one embodiment.

As described above, the system 100 includes a plurality of sensors and a plurality of actuators operatively connected to the controller 750. The sensors are adapted to measure a plurality of parameter values associated with environmental conditions inside the enclosure 102.

Once the parameter values are measured, the controller 750 receives the measured parameter value from the sensors. Each measured parameter value is compared with a target parameter value. An appropriate command for actuating at least one of the actuators is then determined and sent to the at least one of the actuators. The at least one actuator will then be activated, deactivated or adjusted such that the parameter value inside the enclosure 102 becomes closer to or reaches the target parameter value.

In prior art systems, the appropriate command is determined simply using an algorithm with at least one of the measured parameter values as an input. For example, a temperature sensor may measure an air temperature within an enclosure, a controller may receive the measured air temperature and compare the measured air temperature with a target air temperature. If the measured air temperature is lower than the target air temperature, the controller may send a command to a heater inside the enclosure to activate the heater and thereby raise the air temperature inside the enclosure. If the measured air temperature is equal to or higher than the target air temperature, then the controller may send a command to the heater to deactivate the heater. In this example of the prior art, the temperature sensor may provide a measured air temperature at a predetermined frequency and/or the controller may compare the measured air temperature with the target air temperature at a predetermined frequency (e.g. every 30 seconds).

With this type of algorithm, prior art systems therefore use a measured value of a certain parameter, in this case air temperature, and activate an actuator (i.e. the heater) which directly interacts with the parameter.

Unfortunately, this type of algorithm is not adapted to allow a complex system with multiple input parameters and multiple output commands which may or may not be interrelated. For example, the above air temperature algorithm does not consider the effect of air humidity on the air temperature, and does not consider the effect of activating the heater on soil moisture. This type of system is therefore relatively inefficient.

In the present system 100, an artificial neural network 2400 is used to process input parameters 2402 and to output appropriate commands 2404 to the corresponding actuators according to a plurality of target parameter values which are desired inside the enclosure 102. Specifically, the artificial neural network 2400 is a deep network, fully connected and including 1000 hidden nodes. Alternatively, the artificial neural network 2400 could include another type of artificial neural network.

In one embodiment, the input parameters 2402 include a plurality of parameter values measured by the sensors inside the enclosure 102 and a plurality of actuator status values corresponding to a current status of the system's actuators.

In one embodiment, each measured parameter value is associated with one of multiple parameters representing environmental conditions in the enclosure 102. Specifically, the measured parameter values could include an enclosure water level value, a nutrient concentration value, a soil moisture value, an air humidity value and a reservoir water level value, each one of the enclosure water level, nutrient concentration, soil moisture, air humidity and reservoir water level values being expressed as an integer from 0 to 100 inclusively.

The measured parameter values could further include a ground temperature value and an air temperature value, the ground temperature and air temperature values being expressed as an integer from −30 to 50 inclusively corresponding to a temperature in Celsius degrees.

The measured parameter values could further include a pH level value expressed as an integer from 0 to 14 inclusively, a water conductivity level value expressed as an integer from 0 to 200 inclusively, an infrared radiation value expressed as an integer from 0 to 1000 inclusively and an air quality value also expressed as an integer from 0 to 1000 inclusively.

In one embodiment, the actuator status values may include a visible light source status value corresponding to an intensity of the visible light source, an infrared light source status value corresponding to an intensity of the infrared light source, an UV light source status value corresponding to an intensity of the UV light source, a controllable valve status value corresponding to a state of the controllable valve 706, an air fan status value corresponding to a speed of the air fan 510, a water cooler status value corresponding to a state of the water cooler 610, a thermoelectric air cooler/heater status value corresponding to a state of the thermoelectric cooler/heater 700 and an airflow fan status value corresponding to a speed of the airflow fan 2004. Specifically, the visible light source status value, the infrared light source status value, the UV light source status value, the controllable valve status value, the air fan status value, the water cooler status value, the thermoelectric air cooler/heater status value, and the airflow fan status value may each be expressed as an integer from 0 to 100 inclusively.

In one embodiment, the actuator status values may further include an air pump status value corresponding to an indication of whether the air pump 502 is activated, a misting pump status value corresponding to an indication of whether the water misting pump 518 is activated, an irrigation pump status value corresponding to an indication of whether the irrigation pump 702 is activated, a waterfall pump status value corresponding to an indication of whether the waterfall pump 704 is activated, and a nutrient pump status value corresponding to an indication of whether a nutrient pump in communication with the water reservoir 128 is activated. Specifically, the air pump status value, the misting pump status value, the irrigation pump status value, the waterfall pump status value and the nutrient pump status value.

In one embodiment, the target parameter values are provided in a parameter plan which contains a plurality of target parameter values for various parameters over a period of time. The parameter plan could be an annual plan which contains 365 daily plans, each plan corresponding to a day of a calendar year. In one embodiment, each daily plan contains an indication of at least one of a target sunset time, a target sunrise time, a target daytime temperature value, a target maximum air temperature value, a nighttime temperature, a target minimum air temperature, a target maximum humidity, a target minimum humidity, a first rain start time, a first rain end time, a second rain start time, a second rain end time, a target intensity of UVB light, a target intensity of UVA light and infrared light, a target irrigation duration using the irrigation pump 702, a target airflow duration using the internal airflow assembly 2002, a target air pump duration using the air pump 502, a target waterfall pump duration using the waterfall pump 704, a target nutrient concentration value, a target value for the amount of solids in the water, a maximum nutrient water concentration value and a minimum nutrient water concentration value.

It will be understood that within the same annual plan, the target parameter values may vary from one day to the next to simulate changes in conditions over an entire year in a certain climate to be mimicked by the system 100. Those changes could be due to a change in seasons which causes a progressive change in air temperature and humidity, for example, or could be based on historical rainfall data of the mimicked climate.

It will further be appreciated that still within the same annual plan, the target parameter values may vary between different times of the same day. For example, the target intensity of UVB light, UVA light and infrared light may be considerably lowered or even deactivated to simulate nighttime.

It will further be appreciated that different species of organisms may require very different environmental conditions. Therefore, the annual plan could be associated with one specific species, with each species being associated with a unique annual plan.

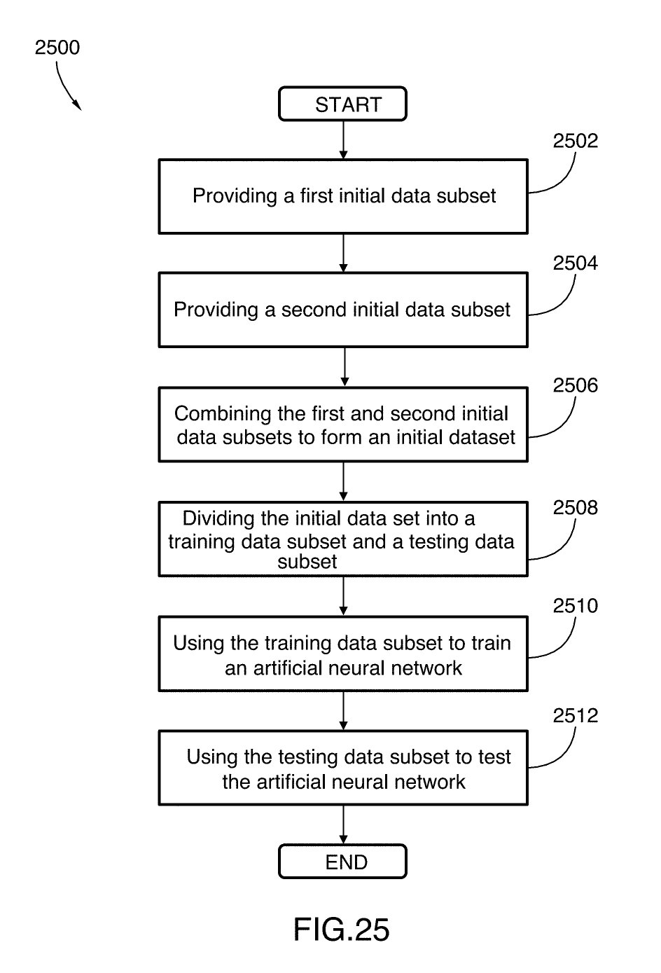

Referring now to FIGS. 24 and 25, it will be appreciated that to efficiently use an artificial neural network, the network must first be trained. In the illustrated embodiment, the artificial neural network 2400 is trained using a “supervised” training method 2500.

According to 2502 and 2504, the method includes providing a first initial data subset 2406 and a second initial data subset 2408.

In one embodiment, the first initial data subset 2408 is generated by inputting random input parameter values into a plurality of base algorithms to obtain a plurality of corresponding output data corresponding to actuator commands. Specifically, the algorithms are adapted to generate actuator commands based on a comparison between the random input parameter values and the corresponding target parameter values of the annual plan.

In one embodiment, the plurality of base algorithms includes a soil temperature control algorithm, an air temperature control algorithm, a humidity control algorithm, a light control algorithm, a soil water saturation algorithm and a nutrient concentration algorithm. Alternatively, the plurality of base algorithms could include additional or different algorithms.

In one embodiment, the soil temperature algorithm includes, in response to a measured value corresponding to the soil temperature being lower than a target soil temperature value, generating a command for activating the first heating cable 162. The soil temperature algorithm further includes, in response to a measured value corresponding to the soil temperature being higher than the target soil temperature value, generating a command for deactivating the first heating cable 162 and a command for activating the water cooler and the irrigation pump 702.

In one embodiment, the air temperature algorithm includes, in response to a measured value corresponding to the air temperature being lower than a target air temperature value, generating a command for activating the ventilation heating element 550, a command for activating the air fan 510 and a command for activating the thermoelectric heater. The air temperature algorithm further includes, in response to a measured value corresponding to the air temperature being higher than the target air temperature value or than a target maximum air temperature value, generating a command for deactivating the ventilation heating element 550, a command for deactivating the air fan 510 and a command for deactivating the thermoelectric heater. The air temperature algorithm further includes, in response to a measured value corresponding to the air temperature being equal to the target air temperature value, generating a command for deactivating the ventilation heating element 550, a command for deactivating the air fan 510 and a command for deactivating the thermoelectric heater.

In one embodiment, the humidity control algorithm includes, in response to a measured value corresponding to the humidity being lower than a target humidity value, generating a command for activating the air pump 502. The humidity control algorithm further includes, in response to a measured value corresponding to the humidity being higher than a target humidity value, generating a command for deactivating the air pump 502 and a command for activating the air fan 510.

In one embodiment, the light control algorithm includes generating a command to activate the visible light source at a predetermined intensity in accordance with a target visible light intensity from the annual plan. The light control algorithm further includes, in response to a measured value corresponding to the air temperature being higher than the target maximum air temperature value, generating a command for reducing the intensity of the visible light source by 10% every minute until reaching a visible light source intensity of 10% and a command for maintaining the visible light source at an intensity of 10% until a measured value corresponding to the air temperature being lower than the target maximum air temperature value is received.

In one embodiment, the light control algorithm further includes generating a command to activate the UV light source at a predetermined intensity in accordance with a target UV light intensity from the annual plan. The light control algorithm may further be adapted to modify the UV light intensity by increments of 10%.

Similarly, the light control algorithm further includes generating a command to activate the infrared light source at a predetermined intensity in accordance with a target infrared light intensity from the annual plan. The light control algorithm may further be adapted to modify the infrared light intensity by increments of 10%.

In one embodiment, the soil water saturation algorithm includes, in response to a measured value corresponding to the soil water saturation being lower than a target soil water saturation value, generating a command for activating the misting pump 518 at intervals of 30 seconds each hour until a measured value corresponding to the soil water saturation being equal to the target soil water saturation value is received. The soil water saturation algorithm further includes, in response to a measured value corresponding to the soil water saturation being higher than a target soil water saturation value, generating a command for reducing an output of the misting pump 518 by 50% until a measured value corresponding to the soil water saturation being equal to the target soil water saturation value is received.

In one embodiment, the nutrient concentration algorithm is selected between an animal nutrient concentration algorithm and a plant nutrient concentration algorithm according to a species type defined in the annual plan.

In one embodiment, the nutrient concentration algorithm operated in the garden mode includes, in response to a measured value corresponding to a nutrient water concentration being lower than a target water nutrient concentration value and to a measured value corresponding to a water level value in the enclosure 102, calculating a water volume in the enclosure 102 based on the water level value and generating a command for activating the nutrient pump once every hour in order to deliver 1.0 ml of nutrient solution per liter of water in the enclosure 102 until a measured value corresponding to the nutrient water concentration being equal to the target water nutrient concentration value is received. The nutrient concentration algorithm operated in the garden mode further includes, in response to a measured value corresponding to the nutrient water concentration being lower than the target water nutrient concentration value, generating a command for activating the irrigation pump 702 and a command for activating the controllable valve 706.

In one embodiment, the nutrient concentration algorithm operated in the animal mode includes, in response to a measured value corresponding to a nutrient water concentration being lower than a target water nutrient concentration value, generating a command for activating the nutrient pump, a command for activating the controllable valve 706, a command for deactivating the misting pump 518

In one embodiment, the base algorithms are simulated. Specifically, the base algorithms may be programmed and executed in a calculation software, with the measured values being generated randomly rather than by the sensors 170, 172. Alternatively, the measured values could be generated by the sensors 170, 172 with different conditions being simulated in the enclosure 102, or random measured values could be inputted into the controller 750 of the system 100 to allow the controller, on which the base algorithms are programmed, to generate the appropriate commands.

In one embodiment, the second initial data subset 2408 includes input parameter values and corresponding actuator commands which may correspond to special cases in which it may be desirable to deviate from the base algorithms. Specifically, each parameter value from the first data subset 2406 and the second data subset 2408 may be associated with one or more identifiers corresponding to an event or state.

In one embodiment, the state is defined by a combination of a disease identifier, a plant condition identifier, an animal condition identifier and a location identifier. The disease identifier could include a numeral between 1 and 100, inclusively. Each of the numeral in this range may refer to a type of disease, a level of disease, or to a combination of disease types and levels. The plant condition identifier, the animal condition identifier and the location identifier could further include a numeral between 1 and 10, inclusively.

The identifiers further include a neutral state, or “non-event”, in which no event is detected. For example, the neutral state could include a disease identifier, a plant condition identifier, an animal condition identifier and a location identifier all equal to 1.

In one embodiment, the first initial data subset 2406 only includes data in the neutral state, while the second initial data subset 2408 only includes data which is non-neutral and which corresponds to events.

According to 2506, the first and second initial data subsets 2406, 2408 are combined to form an initial dataset 2410. It will be understood that by combining the first and second initial data subsets 2406, 2408, the initial dataset 2410 contains data corresponding to both non-event cases and event cases.

In one embodiment, the method 2500 further includes normalizing the data of the initial dataset 2410 in order to convert all of the data to a value between 0 and 1, inclusively.

According to 2508, the initial dataset 2410 is divided into a training data subset 2412 and a testing data subset 2414. In one embodiment, the training data subset 2412 includes 80% of the initial dataset and the testing data subset 2414 includes 20% of the initial dataset. Alternatively, the initial dataset 2410 could be divided according to a different ratio. To form the training data subset 2412 and the testing data subset 2414, data from the initial dataset 2410 can be selected using known sampling methods such as stratified random sampling or any other method that a skilled person would consider appropriate.

According to 2510, the training data subset 2412 is then used to train the neural network 2400. Specifically, corresponding input and output parameter values the training data subset 2412 are used as the corresponding input and output parameters 2402, 2404 of the network 2400 and the neural network 2400 is trained using known training techniques and algorithms to determine appropriate synaptic weights in the network 2400.

In one embodiment, the neural network 2400 is trained for 1000 training iterations. Alternatively, the neural network 2400 could be trained for a different number of training iterations. In one embodiment, the initial synaptic weights of the network are 0.1. Alternatively, other initial synaptic weights could be used. In one embodiment, the neural network 2400 is trained using a training rate of 0.005. Alternatively, the neural network 2400 could trained using a different learning rate.

According to 2512, the testing data subset 2414 is then used to test the neural network 2400. Specifically, the input parameter values 2402 from the training data subset 2412 are inputted into the trained neural network 2400 and the neural network 2400 provides corresponding output parameters values 2404.

Once the trained neural network 2400 has been tested, it can then be used to control the actuators of the system 100 using input parameters 2402 provided by the controller 750.

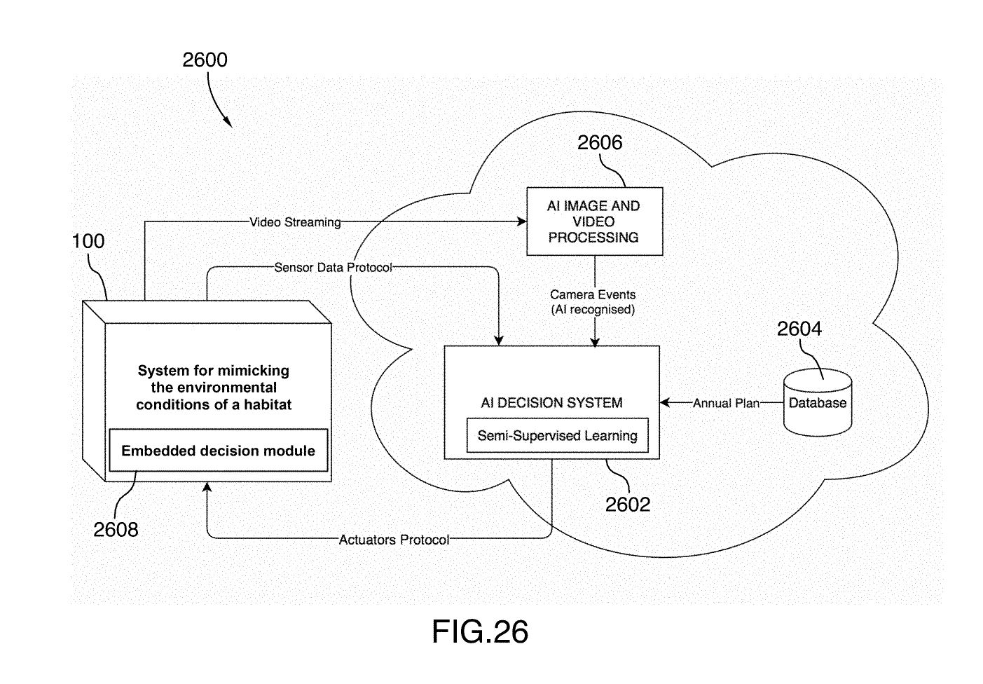

Referring now to FIG. 26, there is shown a control system 2600 for controlling the system 100 for mimicking the environmental conditions of a habitat described above, in accordance with one embodiment.

In this embodiment, the control system 2600 includes a remote server 2602 connected to the system 100 via a communication network. Specifically, the remote server 2602 could be operatively connected to the communication unit of the controller 750 via an Internet connection.

In the embodiment illustrated in FIG. 26, the trained neural network 2400 is provided on a server remote from the system 100. Specifically, the controller 750 is adapted to receive a signal containing measurement data from the sensors 170, 172 and status data from the actuators, and to send the measurement and status data to the remote server using a communication network, such as the Internet. The measurement and status data is then processed using the neural network provided on the remote server to produce at least one actuator command, and the remote server sends back to the controller 750 a command signal containing at least one actuator command to allow the controller 750 to control the actuators of the system 100. In one embodiment, the signal containing measurement and status data is provided from the system 100 to the remote server 2602 every 30 seconds. Alternatively, the signal containing measurement and status data could be provided at a different frequency.

In one embodiment, the control system 2600 further includes a database 2604 operatively connected to the neural network 2400 for storing a plurality of annual plans. As explained above, each annual plan could be associated with a unique species of organisms. When the system 100 is provided with a certain organism, the neural network 2400 uses the annual plan associated with the certain organism for controlling the system 100.

In one embodiment, the remote server 2602 could include a memory and the database 2604 could be stored in the memory of the remote server 2602. Alternatively, the database 2604 could be remote from the remote server 2402 and be accessible to the neural network 2400 via a communication network.

In one embodiment, the system 100 could further be connected to an image processing module 2606 adapted to receive and process images captured by the camera 174. The image processing module 2606 may further be connected to a viewing device such as a personal computer or a smartphone to allow a user to view the images captured by the camera. In one embodiment, the images captured by the camera 174 may include a live video stream. Alternatively, the images captured by the camera 174 may include one or more still images provided upon request or at a certain frequency.

In the illustrated embodiment, the image processing module 2606 is further operatively connected to the neural network 2604. Specifically, the image processing module 2606 may be provided with an image recognition algorithm for associating one or more images received from the system 100 with a specific state of event of the system 100. For example, the image recognition algorithm could be adapted to identify a certain disease in an organism provided in the system 100 by recognizing a certain abnormal color of the organism, or by comparing multiple images taken at different times or different frames of a video and recognizing an abnormal lack of movement of the organism over a certain time period.

The neural network 2604 may then receive from the image processing module 2606 an indication of the state or event identified by the image recognition algorithm, and process the indication as one of the input parameter 2402 to provide the actuator commands to the controller 750.

The image recognition algorithm could include a neural network trained to recognize specific states or events in images, or any other type of algorithm or network which a skilled person would consider suitable.

In one embodiment, the image processing module 2606 is provided on the remote server 2602. Alternatively, the image processing module 2606 could be remote from the remote server 2402 and be accessible to the neural network 2400 via a communication network.

In one embodiment, the neural network 2400 could further be operatively connected to a plurality of other habitat mimicking systems, not shown, which are similar to the system 100. Specifically, the neural network 2400 could be adapted to receive measurement and actuator status data from the other habitat mimicking systems and use the data to improve the neural network 2400.

In the embodiment illustrated in FIG. 26, the system 100 further includes an embedded decision module 2608 which allows the system 100 to be controlled even if the connection between the system 100 and the remote server 2602 is interrupted. Specifically, the embedded decision module 2608 could include the base algorithms described above, which may be programmed on the controller 750. In this embodiment, each command signal sent to the controller 750 contains all of the data needed to command the state of some or all of the actuators of the system 100. Specifically, each command signal contains data related to the annual plan. If connection between the system 100 and the remote server 2602 is interrupted, the controller 750 can then operate in a secondary mode in which it can process data from the last command signal and the measurement and status data from the sensors 170, 172 using the base algorithms to determine commands to be sent to the actuators.

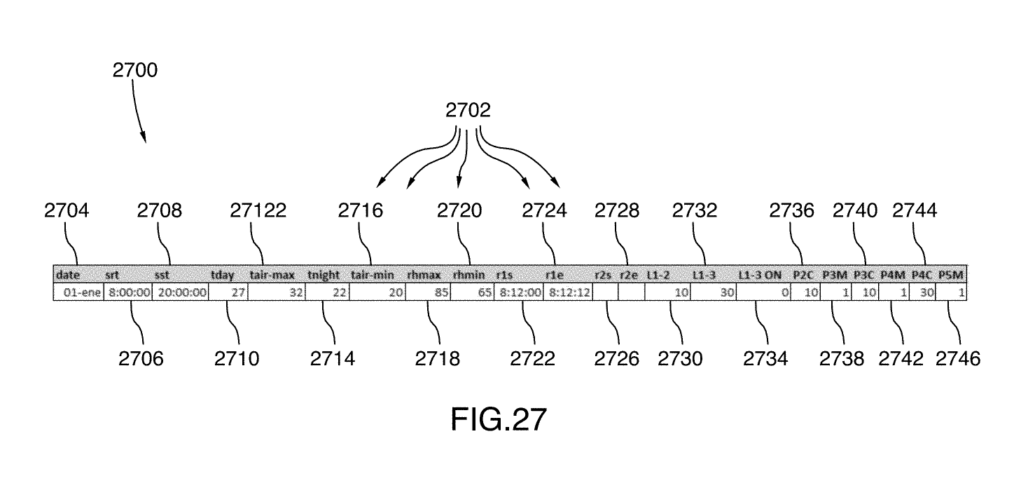

Turning to FIG. 27, the data from the command signal may be arranged in a single command array 2700 which includes a series of values 2702 which correspond to a portion of an annual plan. In one embodiment, a new command array is sent to the controller 750 every 30 seconds. It will be appreciated that should the connection between the remote server and the controller 750 fail, the controller 750 will still hold the last command array and will be able to control the actuators of the system 100 using backup base algorithms stored in its memory, similar to the base algorithms used above to create the first initial data subset.

In one embodiment, the command array 2700 includes a value 2704 indicative of the date. Specifically, the value 2704 indicative of the date may be the first value in the command array 2700.

In one embodiment, the command array 2700 further includes a value 2706 indicative of a desired sunrise time. Specifically, the value 2706 indicative of a desired sunrise time may be disposed immediately after the value indicative of the date 2704.

In one embodiment, the command array 2700 further includes a value 2708 indicative of a desired sunset time. Specifically, the value 2708 indicative of a desired sunset time may be disposed immediately after the value 2706 indicative of a desired sunrise time.

In one embodiment, the command array 2700 further includes a value 2710 indicative of a desired daytime temperature. Specifically, the value 2710 indicative of a desired daytime temperature may be disposed immediately after the value 2708 indicative of a desired sunset time.

In one embodiment, the command array 2700 further includes a value 2712 indicative of a maximum daytime air temperature. Specifically, the value 2712 indicative of a maximum daytime air temperature may be disposed immediately after the value 2714 indicative of a desired daytime temperature.

In one embodiment, the command array 2700 further includes a value 2714 indicative of a desired nighttime temperature. Specifically, the value 2714 indicative of a desired nighttime temperature may be disposed immediately after the value 2712 indicative of a maximum daytime air temperature.

In one embodiment, the command array 2700 further includes a value 2716 indicative of a minimum daytime air temperature. Specifically, the value 2716 indicative of a minimum daytime air temperature may be disposed immediately after the value 2714 indicative of a desired nighttime temperature.

In one embodiment, the command array 2700 further includes a value 2718 indicative of a maximum humidity level. Specifically, the value 2718 indicative of a maximum humidity level may be disposed immediately after the value 2716 indicative of a minimum daytime air temperature.

In one embodiment, the command array 2700 further includes a value 2720 indicative of a maximum humidity level. Specifically, the value 2720 indicative of a minimum humidity level may be disposed immediately after the value 2718 indicative of a maximum humidity level.

In one embodiment, the command array 2700 further includes a value 2722 indicative of a first rain starting time. Specifically, the value 2722 indicative of a first rain starting time may be disposed immediately after the value 2720 indicative of a minimum humidity level.

In one embodiment, the command array 2700 further includes a value 2724 indicative of a first rain ending time. Specifically, the value 2724 indicative of a first rain ending time may be disposed immediately after the value 2722 indicative of a first rain starting time.

In one embodiment, the command array 2700 further includes a value 2726 indicative of a second rain starting time. Specifically, the value 2726 indicative of a second rain starting time may be disposed immediately after the value 2724 indicative of a first rain ending time.

In one embodiment, the command array 2700 further includes a value 2728 indicative of a second rain ending time. Specifically, the value 2728 indicative of a second rain ending time may be disposed immediately after the value 2726 indicative of a second rain starting time.

In one embodiment, the command array 2700 further includes a value 2730 indicative of an intensity of UVB light. Specifically, the value 2730 indicative of an intensity of UVB light may be disposed immediately after the value 2728 indicative of a second rain starting time. In one embodiment, the value 2730 indicative of an intensity of UVB light is expressed as a percentage of intensity at the UV light source is to be activated.

In one embodiment, the command array 2700 further includes a value 2732 indicative of an intensity of UVA light and infrared light. Specifically, the value 2732 indicative of an intensity of UVA light and infrared light may be disposed immediately after the value 2730 indicative of a intensity of UVB light. In one embodiment, the value 2732 indicative of an intensity of UVA light and infrared light is expressed as a percentage of intensity of the infrared light source is to be activated.

In one embodiment, the command array 2700 further includes a value 2734 indicative of a desired operation mode of the UVA light and infrared light. Specifically, the value 2734 indicative of the second rain ending time may be disposed immediately after the value 2732 indicative of a second rain starting time. The value 2734 indicative of the permanent UVA light and infrared light may selectively take the value of “0” and “1”. The value of “0” corresponds to a normal operation mode in which the UV light and infrared light sources are activated when the current time is greater than the desired sunrise time and less than the desired sunset time. The value of “1” corresponds to an override operation mode in which the UV light and infrared light sources are activated and remain activated regardless of the current time.

In one embodiment, the command array 2700 further includes a value 2736 indicative of a desired irrigation duration. Specifically, the value 2736 indicative of a desired irrigation duration may be disposed immediately after the value 2734 indicative of an intensity of UVB light.

In one embodiment, the command array 2700 further includes a value 2738 indicative of a desired operation mode of the air pump 502. In this embodiment, the command array 2700 further includes a value 2740 indicative of a desired activation duration of the air pump 502. The value 2738 indicative of a desired operation mode of the air pump 502 may be disposed immediately after the value 2736 indicative of a desired irrigation duration, and the value 2740 indicative of a desired activation duration of the air pump 502 may be disposed immediately after the value 2738 indicative of a desired operation mode of the air pump 502.

Specifically, the value 2738 indicative of the desired operation mode of the air pump 502 may selectively take the value of “0” and “1”. The value of “0” corresponds to a first mode in which the air pump 502 is deactivated. The value of “1” corresponds to a second mode in which the air pump 502 is activated and remains activated for a duration corresponding to the value 2740 indicative of a desired activation duration of the air pump 502.

In one embodiment, the command array 2700 further includes a value 2742 indicative of a desired operation mode of the air fan 510. In this embodiment, the command array 2700 further includes a value 2744 indicative of a desired activation duration of the air fan 510. The value 2742 indicative of a desired operation mode of the air fan 510 may be disposed immediately after the value 2740 indicative of a desired activation duration of the air pump 502, and the value 2744 indicative of a desired activation duration of the air fan 510 may be disposed immediately after the value 2742 indicative of a desired operation mode of the air fan 510.

Specifically, the value 2742 indicative of the desired operation mode of the air fan 510 may selectively take the value of “0” and “1”. The value of “0” corresponds to a first mode in which the air fan 510 is deactivated. The value of “1” corresponds to a second mode in which the air fan 510 is activated and remains activated for a duration corresponding to the value 2744 indicative of a desired activation duration of the air fan 510.

In one embodiment, the command array 2700 further includes a value 2746 indicative of a desired operation mode of the waterfall pump 704. Specifically, the value 2746 indicative of the desired operation mode of the waterfall pump 704 may be disposed immediately after the value 2744 indicative of the desired operation mode of the air fan 510. The value 2746 indicative of the desired operation mode of the waterfall pump 704 may selectively take the value of “0” and “1”. The value of “0” corresponds to a first operation mode in which the waterfall pump 704 is not activated. The value of “1” corresponds to a second operation mode in which the waterfall pump 704 is activated and remains activated.

It will be understood that although the above values are presented in a particular order within the command array, the command array may include the values arranged in a different order. Alternatively, the command array could include more or less values, or even different values.

We claim:

1. A system for mimicking the environmental conditions of a habitat, the system comprising:
an enclosure for housing at least one organism, the enclosure including a roof, a floor and a plurality of sidewalls extending vertically between the roof and the floor;
a ventilation assembly for providing air from outside the enclosure into the enclosure, the ventilation assembly comprising:
a ventilation strip extending horizontally through one of the sidewalls, the ventilation strip having a first strip end and a second strip end, the ventilation strip including:
a first inner channel extending longitudinally between the left and right strip ends;
a second inner channel extending longitudinally between the left and right strip ends adjacent the first inner channel, the second inner channel being in communication with an exterior of the enclosure;
an inner fin extending between the first inner channel and the second inner channel for separating the first inner channel from the second inner channel;
at least one ventilation opening defined in the ventilation strip for allowing communication between the first inner channel and an interior of the enclosure and between the second inner channel and the interior of the enclosure; and
an air fan in fluid communication with the first inner channel, the air fan being adapted for providing a flow of air into the first inner channel when operated, said flow of air creating a low-pressure zone over the at least one ventilation opening when entering the enclosure through the ventilation opening, thereby drawing air through the ventilation opening and into the enclosure from the exterior of the enclosure through the second inner channel.

2. The system as claimed in claim 1, further comprising:
at least one sensor disposed inside the enclosure, each one of the at least one sensor being configured to measure at least one environmental parameter value within the enclosure;
at least one actuator disposed inside the enclosure, each one of the at least one actuator being configured to adjust the at least one environmental parameter;
a controller operatively connected to the at least one sensor and to the at least one actuator for controlling the at least one environmental parameter according to the measured environmental parameter value.

3. The system as claimed in claim 2, wherein the plurality of sidewalls include a rear wall, a front wall disposed opposite the rear wall and left and right opposite lateral walls extending between the rear and front walls.

4. The system as claimed in claim 3, wherein the front wall includes an upper front wall panel adjacent the roof and a lower front wall panel adjacent the floor, the ventilation strip extending horizontally between the upper and lower front wall panels.

5. The system as claimed in claim 4, wherein the left strip end located adjacent the left lateral wall and the right strip end is located adjacent the right lateral wall.

6. The system as claimed in claim 5, wherein the inner fin is curved.

7. The system as claimed in claim 6, wherein the inner fin is convex towards the first inner channel.

8. The system as claimed in claim 7, wherein the ventilation strip includes a top face contacting the upper front wall panel and a bottom face contacting the lower front wall panel.

9. The system as claimed in claim 8, wherein the top face is planar.

10. The system as claimed in claim 8, wherein the ventilation opening is defined in the top face.

11. The system as claimed in claim 10, wherein each ventilation opening is elongated and extends transversely to the ventilation strip.

12. The system as claimed in claim 11, wherein each ventilation opening includes a first end located towards the first inner channel and a second end located towards the second inner channel.

13. The system as claimed in claim 12, wherein the at least one ventilation opening includes a plurality of spaced-apart ventilations openings.

14. The system as claimed in claim 12, wherein the inner fin member includes a base end secured to the bottom face of the ventilation strip and a free end opposite the base end.

15. The system as claimed in claim 14, wherein the free end of the inner fin abuts the top face below the ventilation opening to divide the ventilation opening into a first opening portion allowing communication between the first inner channel and the interior of the enclosure and a second opening portion allowing communication between the second inner channel and the interior of the enclosure.

16. The system as claimed in claim 15, wherein the second opening portion is larger than the first opening portion.

17. The system as claimed in claim 16, wherein the ventilation opening includes a pair of parallel straight side edges and first and second semicircular end edges extending between the side edges, the first semicircular end edge being disposed towards the interior of the enclosure and the second semicircular end edge being disposed towards the exterior of the enclosure.

18. The system as claimed in claim 17, wherein the free end of the inner fin is disposed between the straight side edges and the first semicircular end edge such that the first opening portion is defined between the free end of the inner fin and the first semicircular end edge.

19. The system as claimed in claim 14, wherein the inner fin tapers from the base end to the free end.

20. The system as claimed in claim 8, wherein the bottom face includes at least one inlet opening allowing communication between the second inner channel and the exterior of the enclosure.

21. The system as claimed in claim 20, wherein at least one inlet opening includes a plurality of spaced-apart inlet openings.

22. The system as claimed in claim 8, wherein the bottom face includes a panel receiving recess extending longitudinally between the left and right strip ends, the panel receiving recess being sized and shaped to receive a top edge of the lower front wall panel.

23. The system as claimed in claim 8, wherein the ventilation strip further includes a heating element extending longitudinally between the left and right strip ends, the heating element being disposed adjacent the first inner channel to provide heat to air within the first inner channel.

24. The system as claimed in claim 23, wherein the heating element has a cylindrical cross-section and the bottom face of the ventilation strip includes a heating element recess having a corresponding cylindrical cross-section for receiving the heating element.

25. The system as claimed in claim 24, wherein the heating element includes a heating cable.

26. A system for mimicking the environmental conditions of a habitat, the system comprising:
an enclosure for housing at least one organism, the enclosure including a roof, a floor and a plurality of sidewalls extending vertically between the roof and the floor;
a vertical growing assembly located inside the enclosure for allowing the at least one organism to grow on one of the sidewalls, the vertical growing assembly including:
a mounting panel disposed vertically against the one of the sidewalls; and
a plurality of cells extending from the mounting panel into the enclosure, each cell being adapted for receiving substrate for growing the at least one organism.

27. The system as claimed in claim 26, wherein the plurality of cells comprise:
a plurality of spaced-apart vertical bar members extending from the mounting panel into the enclosure; and
a plurality of diagonal slats angled upwardly relative to the mounting panel and extending between the vertical bar members.

28. The system as claimed in claim 27, wherein the vertical growing assembly further includes:
a top water distribution member disposed at a top end of the mounting panel; and
a vertical irrigation pipe having an upper end operatively connected to the top water distribution member and a lower end operatively connected to an irrigation pump for dispensing water from a water reservoir through the pipe and into the top water distribution member.

29. The system as claimed in claim 28, wherein the top water distribution member includes at least one top drip holes to allow water from the top water distribution member to flow down towards the diagonal slats.

30. The system as claimed in claim 29, wherein the top water distribution member includes:
a bottom portion connected to the mounting panel; and
a front portion angled away from the mounting panel, the front portion defining an upper horizontal edge located away from the mounting panel.

31. The system as claimed in claim 30, wherein each top drip holes is spaced from the bottom portion for allowing water to accumulate on the bottom portion before flowing through the top drip holes when water is provided in the top water distribution member.

32. The system as claimed in claim 31, wherein each top drip hole includes an indent extending in the front portion towards the bottom portion.

33. The system as claimed in claim 32, wherein the top water distribution member further includes at least one adjustable stopper, each one of the at least one adjustable stopper being adapted to at least partially block one of the at least one top drip holes.

34. The system as claimed in claim 33, wherein the vertical growing assembly further includes at least one lower water distribution member, each one of the at least one lower water distribution member extending between a corresponding row of diagonal slats and the mounting panel.

35. The system as claimed in claim 34, wherein the lower water distribution member includes a plurality of lower drip holes to allow water from the lower water distribution member to flow downwardly towards the floor of the enclosure.

36. The system as claimed in claim 35, wherein the diagonal slats are horizontally spaced away from the mounting panel to allow water dripping from the top water distribution member down through the top drip holes to drip between the diagonal slats and the mounting panel and to be received in the lower water distribution member.

37. A method for training an artificial neural network to control a system for mimicking the environmental conditions of a habitat, the system including an enclosure for housing at least one organism, at least one sensor disposed inside the enclosure, each one of the at least one sensor being configured to measure at least one environmental parameter value within the enclosure, and at least one actuator disposed inside the enclosure, each one of the at least one actuator being configured to adjust the at least one environmental parameter, the method comprising:
providing a first initial data subset containing a first plurality of input parameter values and corresponding output parameter values;
providing a second initial data subset containing a second plurality of input parameter values and corresponding output parameter values;
combining the first and second initial data subsets to form an initial data set;
dividing the initial data set into a training data subset and a testing data subset;
using the training data subset to train the artificial neural network;
using the testing data subset to test the trained artificial neural network.

38. The method as claimed in claim 37, wherein providing a first initial data subset includes:
randomly generating input parameter values;
inputting the input parameter values into a plurality of base algorithms, each base algorithm comparing at least one of the random parameter values to a corresponding at least one target parameter value to obtain at least one actuator command for actuating the at least one actuator.

39. The method as claimed in claim 37, wherein the first plurality of input parameter values includes measurement values corresponding to measurements from the at least one sensor and actuator status values corresponding to statuses of the at least one actuator.

40. The method as claimed in claim 37, wherein each parameter value from the first data subset and the second data subset is associated with at least one identifier corresponding to an event or state related to the at least one organism inside the enclosure.

41. The method as claimed in claim 40, wherein the at least one identifier includes a no-event identifier corresponding to no event being detected and a plurality of event identifiers, each event identifier corresponding to a specific event.

42. The method as claimed in claim 41, wherein the first initial data subset only includes parameter values associated with a no-event identifier and the second initial data subset only includes parameter values associated with event identifiers.
